(19) United States
(12) Patent Application Publication
(10) Pub. No.: US 2026/0269884 A1
(43) Pub. Date: Sep. 10, 2026

(54) WIRELESS COMMUNICATION CONTROL DEVICE AND WIRELESS COMMUNICATION CONTROL METHOD

(71) Applicant: Sony Group Corporation, Tokyo (JP)

(72) Inventors: Kazuyuki SAKODA, Tokyo (JP); Kosuke AIO, Tokyo (JP); Ken TANAKA, Stuttgart (DE)

(73) Assignee: Sony Group Corporation, Tokyo (JP)

(21) Appl. No.: 19/165,601

(22) PCT Filed: Mar. 5, 2024
(86) PCT No.: PCT/JP2024/008174

§ 371 Date: Sep. 16, 2025

(30) Foreign Application Priority Data
Mar. 29, 2023 (JP) 2023-053263

(51) Int. Cl. H04B 7/0452

(52) U.S. Cl. CPC H04B 7/0452

(57) ABSTRACT

A wireless communication section includes a communication control section that controls communication for a console apparatus and controls transmission of video information to a station apparatus in cooperation with another wireless communication section that controls the communication for the console apparatus. The present technology can be applied, for example, to a wireless communication system or the like including: a console apparatus including a communication control section that controls communication with an AP apparatus via the Fronthaul Link and another communication control section that controls communication with a station apparatus via the P2P Link; and another station apparatus that performs communication with the AP apparatus via the Fronthaul Link.

### TECHNICAL FIELD

The present technology relates to a wireless communication control device and a wireless communication control method, and relates to a wireless communication control device and a wireless communication control method that make it possible to perform transmission in a wireless communication control device using a large number of transmission antennas when there is a wireless communication control device that controls communication for the same wireless terminal apparatus in addition to a wireless communication control device that does not connect to the large number of transmission antennas.

### BACKGROUND ART

In recent years, expectations for next-generation applications using Extended Reality (XR) technologies such as Virtual Reality (VR) and Augmented Reality (AR) have been increasing. The use case for such next-generation applications is currently assumed to be a wired connection between a console apparatus that generates video information and a head-mounted display (HMD) as a display apparatus that displays videos.

However, in recent years, wireless kit products that eliminate the need for wires that connect the console apparatus and the HMD have been commercialized, and it is predicted that the trend toward a complete wireless connection between the console apparatus dan the HMD will accelerate in the future.

The console apparatus generally includes a chip of a wireless local area network (LAN), and operates as a wireless terminal apparatus that acquires information from an access point apparatus installed by a user. Therefore, if a wireless terminal apparatus other than the console apparatus is connected to this access point apparatus, the wireless communication between the console apparatus and the HMD competes with wireless communication between the access point apparatus and the wireless terminal apparatus. This may prevent some frequency bands from being used in the wireless communication between the console apparatus and the HMD.

However, since video information with a large amount of data needs to be transmitted with low latency between the console apparatus and the HMD, high-capacity transmission using wide-area channels is required. As a result, the following problem occurs: the throughput between the console apparatus and the HMD is reduced, or transmission delays increase due to waiting for transmission.

In this regard, there is a need for a technology that can maintain sufficient transmission quality even if the access point apparatus and the console apparatus simultaneously perform transmission in the same frequency resource.

Examples of such technologies include the coordinated beamforming (Co-BF) technology. If the Co-BF technology is used, the access point apparatus and the console apparatus each form a beam and suppress the received power observed by each other's transmission destination (form a NULL) to thereby reduce interference. This allows the access point apparatus and the console apparatus to maintain sufficient transmission quality even if they simultaneously perform transmission in the same frequency resource.

It should be noted that the formation of a NULL in the Co-BF technology requires a large number of transmission antennas. However, it may be difficult to install a large number of transmission antennas due to limitations in the apparatus configuration in the console apparatus or the wireless terminal apparatus such as a wireless kit product.

On the other hand, there is a technology called Enhanced Multi-Link Single Radio in which an antenna or amplifier of one station apparatus of two station apparatuses belonging to the same multi-link device (MLD) is used by the other station apparatus (for example, see Non-Patent Literature 1). This technology makes it possible to simultaneously perform a multi-link operation and MIMO transmission with a simple configuration.

### CITATION LIST

### Non-Patent Literature

Non-Patent Literature 1: “Enhanced Multi-Link Single Radio Operation”, IEEE802.11-20/0562r7

### DISCLOSURE OF INVENTION

### Technical Problem

There has not been devised the technique of performing transmission in a wireless communication control device using a large number of transmission antennas when there is a wireless communication control device that controls communication for the same wireless terminal apparatus in addition to a wireless communication control device that does not connect to the large number of transmission antennas.

The present technology has been made in view of the circumstances as described above and makes it possible to perform transmission in a wireless communication control device using a large number of transmission antennas when there is a wireless communication control device that controls communication for the same wireless terminal apparatus in addition to a wireless communication control device that does not connect to the large number of transmission antennas.

### Solution to Problem

A wireless communication control device according to one aspect of the present technology is a wireless communication control device including a communication control section that controls communication for a first wireless terminal apparatus, and controls transmission of first data to a second wireless terminal apparatus in cooperation with another wireless communication control device that controls the communication for the first wireless terminal apparatus.

A wireless communication control method according to one aspect of the present technology is a wireless communication control method for a wireless communication control device, the method including a communication control step of controlling communication for a first wireless terminal apparatus, and controlling transmission of first data to a second wireless terminal apparatus in cooperation with another wireless communication control device that controls the communication for the first wireless terminal apparatus.

In one aspect of the present technology, when communication for a first wireless terminal apparatus is controlled, transmission of first data to a second wireless terminal apparatus is controlled in cooperation with another wireless communication control device that controls the communication for the first wireless terminal apparatus.

The wireless communication control device may be a stand-alone device or may be a module incorporated into another device.

Note that the wireless communication control device according to one aspect of the present technology can be achieved by causing a computer to execute a program.

Further, in order to achieve the wireless communication control device according to the first and second aspects of the present technology, the program executed by the computer can be provided by being transmitted via a transmission medium or being recorded on a recording medium.

### BRIEF DESCRIPTION OF DRAWINGS

FIG. 1 is a diagram showing a configuration example of one embodiment of a wireless communication system to which the present technology is applied.

FIG. 2 is a block diagram showing a configuration example of an AP apparatus.

FIG. 3 is a block diagram showing a configuration example of a console apparatus.

FIG. 4 is a block diagram showing a configuration example of a station apparatus.

FIG. 5 is a diagram for describing an effect by the wireless communication system.

FIG. 6 is another diagram for describing an effect by the wireless communication system.

FIG. 7 is a flowchart for describing wireless communication processing.

FIG. 8 is a flowchart for describing setup processing.

FIG. 9 is a diagram for describing a first example of detection processing.

FIG. 10 is a diagram for describing a second example of the detection processing.

FIG. 11 is a diagram showing an example of a frame structure of an SSDC Setup Report.

FIG. 12 is a flowchart for describing a first example of sounding processing.

FIG. 13 is a flowchart for describing a second example of the sounding processing.

FIG. 14 is a flowchart for describing coordination transmission processing.

FIG. 15 is a diagram showing a frame structure example of a Coordination Request.

FIG. 16 is a diagram showing a frame structure example of a Coordination Response.

FIG. 17 is a diagram for describing a first example of SSDC preparation processing.

FIG. 18 is a diagram for describing a second example of the SSDC preparation processing.

FIG. 19 is a diagram for describing a third example of the SSDC preparation processing.

FIG. 20 is a diagram for describing a fourth example of the SSDC preparation processing.

FIG. 21 is a diagram for describing a fifth example of the SSDC preparation processing.

FIG. 22 is a block diagram showing a hardware configuration example of a computer.

### MODE(S) FOR CARRYING OUT THE INVENTION

Embodiments for carrying out the present technology (hereinafter, referred to as embodiments) will be described below. Note that the description will be given in the following order.
1. One Embodiment (Wireless Communication System)
2. Computer

### 1. One Embodiment

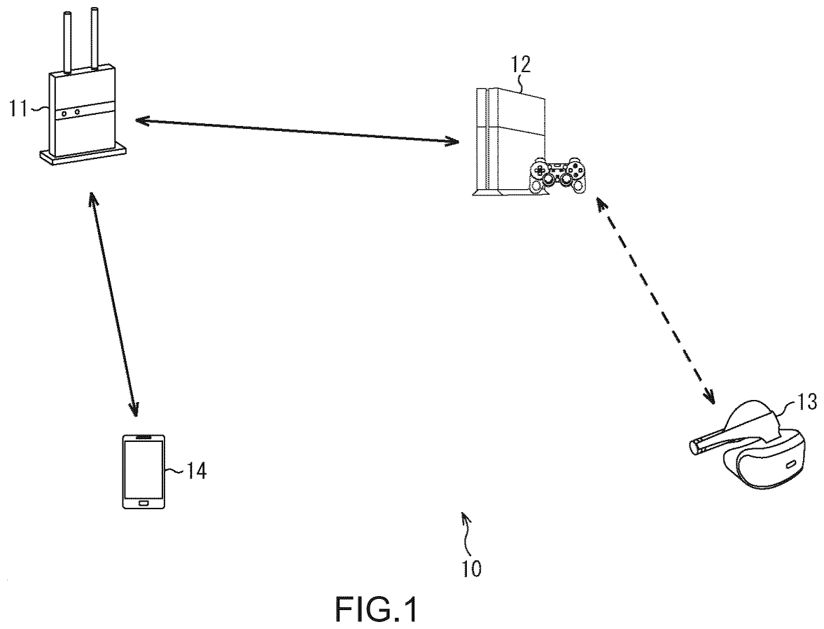

FIG. 1 is a diagram showing a configuration example of one embodiment of a wireless communication system to which the present technology is applied.

A wireless communication system 10 of FIG. 1 includes a single access point (AP) apparatus 11, a single console apparatus 12, and two station apparatuses 13 and 14.

The AP apparatus 11 is a wireless terminal apparatus that functions as a base station and performs wireless communication with the console apparatus 12 and the station apparatus 14. The console apparatus 12 is a wireless terminal apparatus that performs wireless communication with the AP apparatus 11 and the station apparatus 13.

The station apparatus 13 is a display apparatus such as an HMD. The station apparatus 13 is a wireless terminal apparatus that functions as a slave device and performs wireless communication with the console apparatus 12. The station apparatus 13 receives video information from the console apparatus 12 and displays videos on the basis of the video information.

The station apparatus 14 is a wireless terminal apparatus that functions as a slave device and performs wireless communication with the AP apparatus 11. The station apparatus 14 downloads or uploads data, for example, via the AP apparatus 11.

Note that hereinafter the links that connect the AP apparatus 11 and the console apparatus 12 and connect the AP apparatus 11 (third wireless terminal apparatus) and the station apparatus 14 (fourth wireless terminal apparatus) to perform wireless communication, which are indicated by the arrows of the solid lines shown in FIG. 1, are each referred to as a Fronthaul Link (second link). The link that connects the console apparatus 12 and the station apparatus 13 to perform wireless communication, which is indicated by the arrow of the dotted line shown in FIG. 1, is referred to as a P2P Link (first link).

In the wireless communication system 10 configured as described above, the AP apparatus 11 and the console apparatus 12 simultaneously perform transmission in the same channel by using the Co-BF technology. Hereinafter, such transmission will be referred to as coordination transmission.

Note that the configuration of the wireless communication system 10 is not limited to the configuration shown in FIG. 1 as long as there is a plurality of wireless terminal apparatuses that establishes connection and a wireless terminal apparatus serving as a peripheral terminal apparatus exists for each of the plurality of wireless terminal apparatuses. The position relationship between the wireless terminal apparatuses in the wireless communication system 10 is not particularly limited.

### <Configuration Example of AP Apparatus>

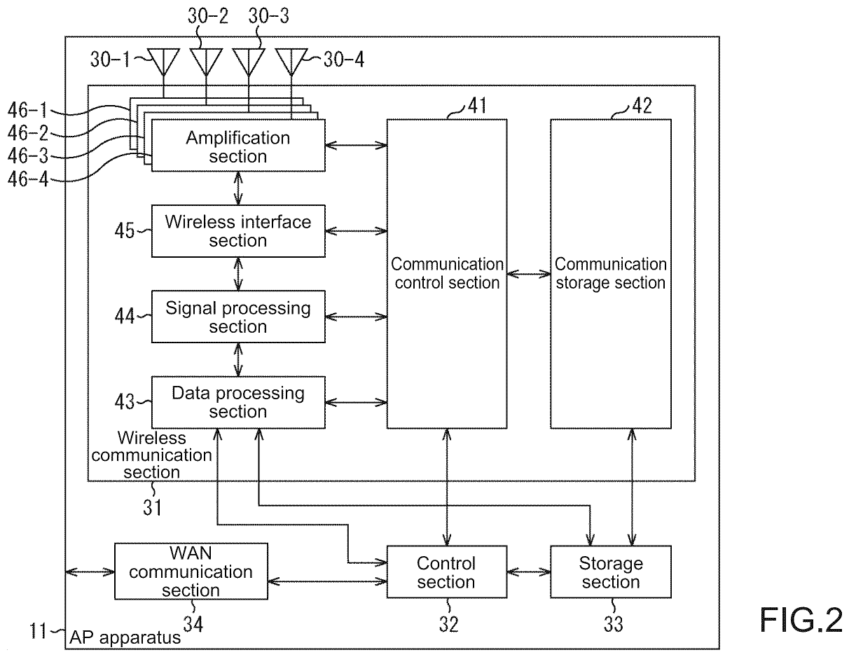

FIG. 2 is a block diagram showing a configuration example of the AP apparatus 11 shown in FIG. 1.

The AP apparatus 11 includes four antennas 30-1 to 30-4, a wireless communication section 31, a control section 32, a storage section 33, and a wide area network (WAN) communication section 34.

The wireless communication section 31 performs wireless communication with the console apparatus 12 and the station apparatus 14, which connect to the wireless communication section 31, via the Fronthaul Link. Specifically, the wireless communication section 31 includes a communication control section 41, a communication storage section 42, a data processing section 43, a signal processing section 44, a wireless interface section 45, and amplification sections 46-1 to 46-4.

The communication control section 41 controls the operation of each section of the wireless communication section 31 and the exchange of information between the sections to control wireless communication with the console apparatus 12 and the station apparatus 14. For example, the communication control section 41 supplies data packets supplied from the control section 32, as transmitted packets, to the communication storage section 42 and causes the communication storage section 42 to store the data packets. The communication control section 41 supplies the received packets supplied from the data processing section 43 to the communication storage section 42 and causes the communication storage section 42 to store the packets. The communication control section 41 further generates control information and management information to be notified to the console apparatus 12 and the station apparatus 14 and supplies the control information and the management information to the data processing section 43.

The communication storage section 42 stores information to be used in the communication control section 41. The communication storage section 42 stores the transmitted packets, which are supplied from the communication control section 41, in a built-in transmission buffer. The communication storage section 42 stores the received packets, which are supplied from the communication control section 41, in a built-in reception buffer.

The data processing section 43 performs sequence management of the transmitted packets, the control information, and the management information, which are supplied from the communication control section 41. The data processing section 43 performs encoding, modulation, and the like on the transmitted packets, the control information, and the management information, adds media access control (MAC) headers and error-detecting codes thereto, and generates MAC frames (PSDU (PLCP (Physical Layer Convergence Protocol) Service Data Unit). The data processing section 43 performs processing of coupling a plurality of generated MAC frames, and the like, and supplies the resultant MAC frames to the signal processing section 44.

The data processing section 43 performs decoupling of MAC headers, analysis such as demodulation and decoding, error detection, and retransmission requests on the MAC frames supplied from the signal processing section 44. The data processing section 43 supplies the data packets obtained as a result of analyzing the MAC frames, as received packets, to the communication control section 41.

The signal processing section 44 performs coding, interleaving, modulation, and the like on the MAC frames supplied from the data processing section 43, adds physical headers, and generates a symbol stream. The signal processing section 44 supplies the symbol stream to the wireless interface section 45.

The signal processing section 44 analyzes the physical headers supplied from the wireless interface section 45, and performs demodulation, deinterleaving, decoding, and the like on the symbol stream, and generates MAC frames. At that time, the signal processing section 44 estimates complex channel characteristics and performs spatial separation processing as necessary. The signal processing section 44 supplies the generated MAC frames to the data processing section 43.

The wireless interface section 45 performs digital-to-analog signal conversion, filtering, up-conversion, and phase control on the symbol stream supplied from the signal processing section 44 to generate transmission signals. The wireless interface section 45 supplies the transmission signals to at least one of the amplification sections 46-1 to 46-4.

The wireless interface section 45 performs down-conversion, filtering, and analog-to-digital signal conversion on the received signals supplied from at least one of the amplification sections 46-1 to 46-4 to generate a symbol stream. The wireless interface section 45 supplies the symbol stream to the signal processing section 44.

The amplification sections 46-1 to 46-4 are respectively connected to the antennas 30-1 to 30-4. Note that if it is not necessary to distinguish between the amplification sections 46-1 to 46-4, hereinafter they are collectively referred to as amplification section 46. The antennas 30-1 to 30-4 are also collectively referred to as antenna 30.

The amplification section 46 amplifies the transmission signals supplied from the wireless interface section 45 and transmits the resultant signals from the antenna 30 connected to the amplification section 46. The amplification section 46 amplifies the received signals, which are the signals received by the antenna 30 connected to the amplification section 46, and supplies the resultant signals to the wireless interface section 45. Some of the constituent elements of the amplification section 46 may be provided outside of the amplification section 46. For example, some of the constituent elements of the amplification section 46 can be included in the wireless interface section 45.

Note that, in the example of FIG. 2, the AP apparatus 11 includes the four sets of the amplification section 46 and the antenna 30 and achieves 4×4 MIMO (Multi Input Multi Output), but the number of sets is not limited to four. As the number of sets of the amplification section 46 and the antenna 30 increases, higher-dimensional MIMO is made possible.

In the example of FIG. 2, the number of sets of the data processing section 43, the signal processing section 44, and the wireless interface section 45 included in the AP apparatus 11 is one, but the number of sets may be more than one. The AP apparatus 11 can perform wireless communication in parallel via a plurality of links or a plurality of channels by providing a plurality of those sets.

The wireless communication section 31 may include a single integrated circuit (IC) or a plurality of ICs. For example, if the wireless communication section 31 includes a plurality of ICs, the wireless interface section 45 and the other sections are formed of separate ICs.

The control section 32 controls the entire AP apparatus 11. For example, the control section 32 controls the WAN communication section 34 to receive data packets, and supplies the data packets to the storage section 33 to be stored therein. The control section 32 reads the data packets from the storage section 33 and supplies the data packets to the communication control section 41. The control section 32 reads the received packets from the communication storage section 42 via the communication control section 41 and supplies the received packets to the storage section 33 to be stored therein. The control section 32 reads the received packets and supplies the received packets to the WAN communication section 34 to be transmitted.

The control section 32 may perform part of the control by the communication control section 41 instead of the communication control section 41. For example, the control section 32 may exchange data packets directly with the data processing section 43. The communication control section 41 and the control section 32 may be integrated into a single section.

The storage section 33 stores information to be used in the wireless communication section 31 and the control section 32. For example, the storage section 33 stores the data packets received from the WAN communication section 34. The storage section 33 may perform part of the operation of the communication storage section 42 instead of the communication storage section 42. The storage section 33 and the communication storage section 42 may be integrated into a single section. The storage section 33 may exchange data packets directly with the communication storage section 42 and the data processing section 43.

The WAN communication section 34 decodes the data packets received via the WAN (backhaul) and supplies the resultant data packets to the control section 32. The format of the data packets supplied to the control section 32 may be a format in which the internet protocol (IP) header is left (access point mode) or a format in which the IP header is removed (router mode). If the format of the data packets supplied to the control section 32 is a format in which the IP header is removed, the WAN communication section 34 removes the IP header after decoding it. The WAN communication section 34 transmits the received packets supplied from the control section 32 via the WAN.

### <Configuration Example of Console Apparatus>

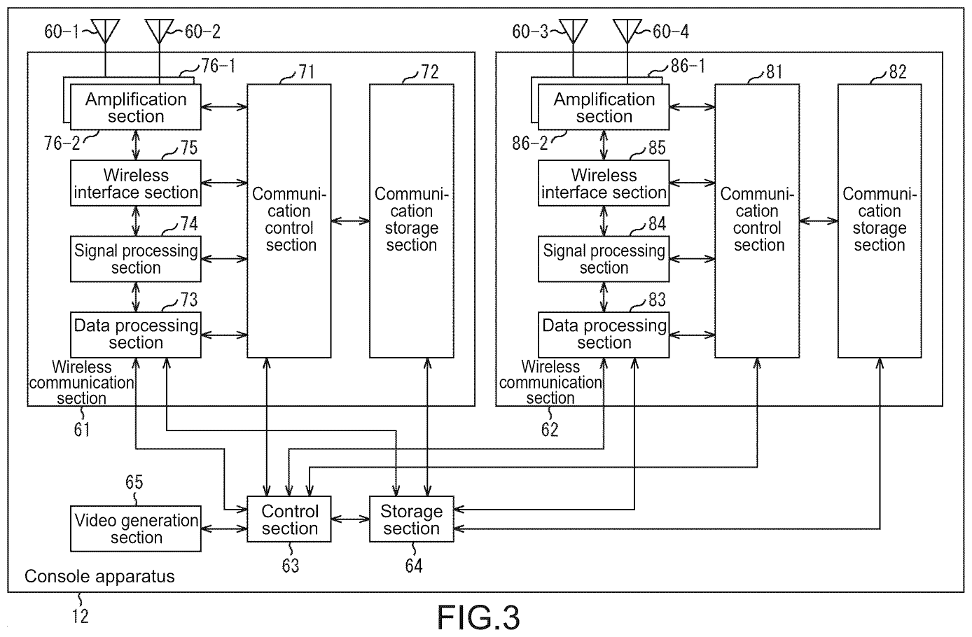

FIG. 3 is a block diagram showing a configuration example of the console apparatus 12 shown in FIG. 1.

The console apparatus 12 of FIG. 3 includes four antennas 60-1 to 60-4, two wireless communication sections 61 and 62, a control section 63, a storage section 64, and a video generation section 65.

The wireless communication section 61 (wireless communication control device) performs wireless communication with the AP apparatus 11 connected to the wireless communication section 61 via the Fronthaul Link. The wireless communication section 61 also performs wireless communication with the station apparatus 13 (second wireless terminal apparatus) connected to the wireless communication section 62, via the P2P Link in cooperation with the wireless communication section 62.

Specifically, the wireless communication section 61 includes a communication control section 71, a communication storage section 72, a data processing section 73 (modulation section), a signal processing section 74 (modulation section), a wireless interface section 75, and amplification sections 76-1 and 76-2. The amplification sections 76-1 and 76-2 are respectively connected to the antennas 60-1 and 60-2.

The processing of each section of the wireless communication section 61 is similar to the processing of each section of the wireless communication section 31 of FIG. 2, except that the communication partner is the AP apparatus 11 and that transmission is performed to the station apparatus 13 in cooperation with the wireless communication section 62, and thus the description thereof will be omitted.

The wireless communication section 62 (wireless communication control device) performs wireless communication with the station apparatus 13 connected to the wireless communication section 62 via the P2P Link. The wireless communication section 62 also performs transmission to the station apparatus 13 in cooperation with the wireless communication section 61. Specifically, the wireless communication section 62 includes a communication control section 81, a communication storage section 82, a data processing section 83 (modulation section), a signal processing section 84 (modulation section), a wireless interface section 85, and amplification sections 86-1 and 86-2. The amplification sections 86-1 and 86-2 are respectively connected to the antennas 60-3 and 60-4.

The processing of each section of the wireless communication section 62 is similar to the processing of each section of the wireless communication section 31, except that the communication partner is the station apparatus 13 and that transmission is performed to the station apparatus 13 in cooperation with the wireless communication section 61, and thus the description thereof will be omitted.

Note that, in the example shown in FIG. 3, the wireless communication section 62 is provided inside the console apparatus 12, but it may be provided outside the console apparatus 12. In this case, the console apparatus 12 and the wireless communication section 62 are connected via wires such as a universal serial bus (USB) and a high definition multimedia interface (HDMI) (registered trademark).

The control section 63 includes, for example, a central processing unit (CPU) and controls the entire console apparatus 12. For example, the control section 63 acquires data packets, received from the AP apparatus 11 and stored as the received packets in the communication storage section 72, via the communication control section 71, and supplies the data packets to the storage section 64 to be stored therein. The control section 63 acquires data packets, received from the station apparatus 13 and stored as the received packets in the communication storage section 82, via the communication control section 81, and supplies the data packets to the storage section 64 to be stored therein.

The control section 63 analyzes the received packets stored in the storage section 64 and gives an instruction regarding video processing to the video generation section 65. The control section 63 supplies the data packets of video information supplied from the video generation section 65 in response to this instruction, as transmitted packets, to the storage section 64 to be stored therein. The control section 63 reads and supplies those transmitted packets to the communication control sections 71 and 81 that control communication for the console apparatus 12 (first wireless terminal apparatus), and causes the communication control sections 71 and 81 to transmit those packets to the station apparatus 13 in cooperation with each other.

Note that the control section 63 may directly exchange the transmitted packets and the received packets with the data processing sections 73 and 83.

The storage section 64 stores the received packets supplied from the control section 63. The storage section 64 stores the transmitted packets supplied from the control section 63. Note that if direct memory access (DMA) is enabled in the console apparatus 12, the storage section 64 can directly exchange the transmitted packets and the received packets with the communication storage section 72, the data processing section 73, the communication storage section 82, the data processing section 83, and the like.

The video generation section 65 includes, for example, a graphics processing unit (GPU). The video generation section 65 performs video processing such as rendering processing or compression processing on the basis of the instruction from the control section 63, generates video information to be transmitted to the station apparatus 13, and supplies it to the control section 63. Note that, in this embodiment, the information transmitted from the console apparatus 12 to the station apparatus 13 is video information, but it may be information other than the video information.

In the following description, if it is not particularly necessary to distinguish between the antennas 60-1 to 60-4, they are collectively referred to as antenna 60.

### <Configuration Example of Station Apparatus>

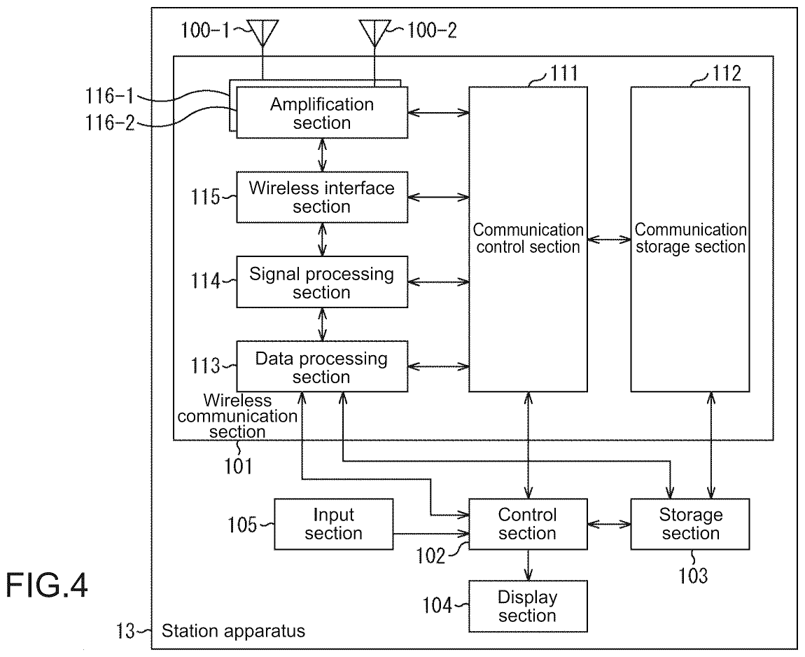

FIG. 4 is a block diagram showing a configuration example of the station apparatus 13 shown in FIG. 1.

The station apparatus 13 includes a wireless communication section 101, a control section 102, a storage section 103, a display section 104, and an input section 105.

The wireless communication section 101 performs wireless communication with the console apparatus 12 via the P2P Link. Specifically, the wireless communication section 101 includes a communication control section 111, a communication storage section 112, a data processing section 113, a signal processing section 114, a wireless interface section 115, and amplification sections 116-1 and 116-2. The amplification sections 116-1 and 116-2 are respectively connected to antennas 100-1 and 100-2. The processing of each section of the wireless communication section 101 is similar to the processing of each section of the wireless communication section 31 of FIG. 2, except that the communication partner is the console apparatus 12, and thus the description thereof will be omitted.

The control section 102 controls the entire station apparatus 13. For example, the control section 102 receives instruction information indicating a user's instruction regarding video processing from the input section 105, and supplies the data packets of that instruction information, as transmitted packets, to the storage section 103 to be stored therein. The control section 102 reads the transmitted packets from the storage section 103 and supplies them to the communication control section 111.

The control section 102 reads the received packets from the communication storage section 112 via the communication control section 111, and suppliers them to the storage section 103 to be stored therein. The control section 102 reads the received packets from the storage section 103, and performs decompression, analysis, or the like on the received packets, and supplies the resulting video information to the display section 104 for display.

The control section 102 may perform part of the control by the communication control section 111 instead of the communication control section 111. For example, the control section 102 may exchange the transmitted packets and received packets directly with the data processing section 113. The communication control section 111 and the control section 102 may be integrated into a single section.

The storage section 103 stores information to be used in the wireless communication section 101 and the control section 102. For example, the storage section 103 stores the transmitted packets supplied from the control section 102. The storage section 103 stores the received packets supplied from the control section 102. The storage section 103 may perform part of the operation of the communication storage section 112 instead of the communication storage section 42. The storage section 103 and the communication storage section 112 may be integrated into a single section. The storage section 103 may exchange the transmitted packets and received packets directly with the communication storage section 112 and the data processing section 113.

The display section 104 includes, for example, a display. The display section 104 performs display on the basis of the video information supplied from the control section 102. Note that the display section 104 may perform part of the processing of the video generation section 65 of FIG. 3 instead of the video generation section 65. In this case, for example, the video generation section 65 generates information that is the basis for rendering processing, as video information, and the display section 104 performs rendering processing on the basis of the video information.

The input section 105 accepts an instruction regarding the video processing from the user and supplies instruction information indicating that instruction to the control section 102.

In the following description, if it is not particularly necessary to distinguish between the antennas 100-1 and 100-2, they are collectively referred to as antenna 100.

Note that the station apparatus 14 is different from the station apparatus 13 in that the communication partner is the AP apparatus 11 and that the received packets and transmitted packets, and the contents of the instruction information are matched with the function of the station apparatus 14. The station apparatus 14 is configured similarly to the station apparatus 13 in the other points. Therefore, the illustration and description of the configuration of the station apparatus 14 will be omitted.

For example, the received packets in the station apparatus 14 are data packets of downloaded data, the transmitted packets are data packets of uploaded data, and the instruction information is information indicating an instruction regarding the downloading or uploading of data.

### <Effects of Wireless Communication System>

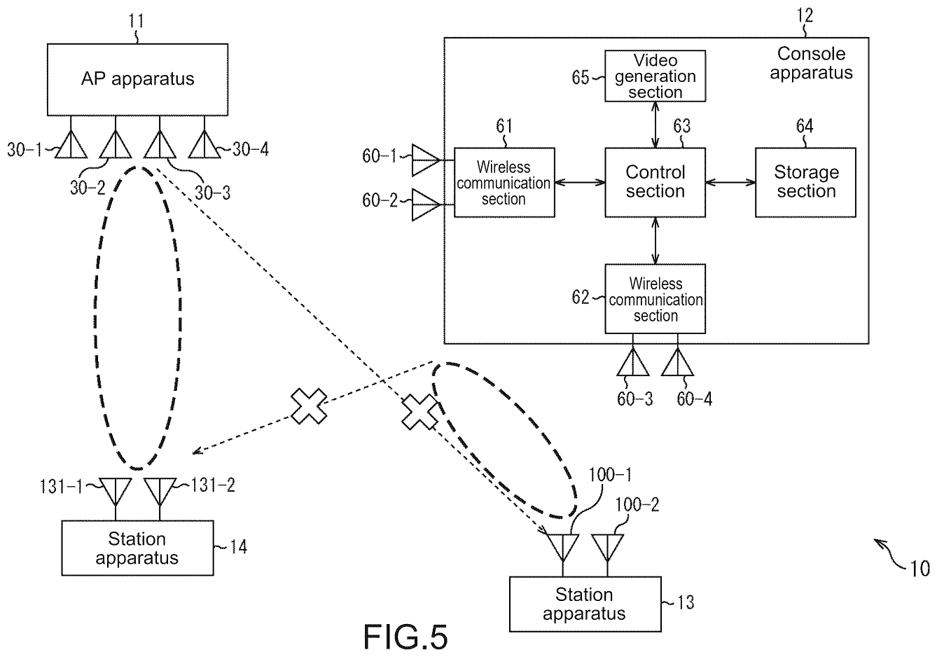

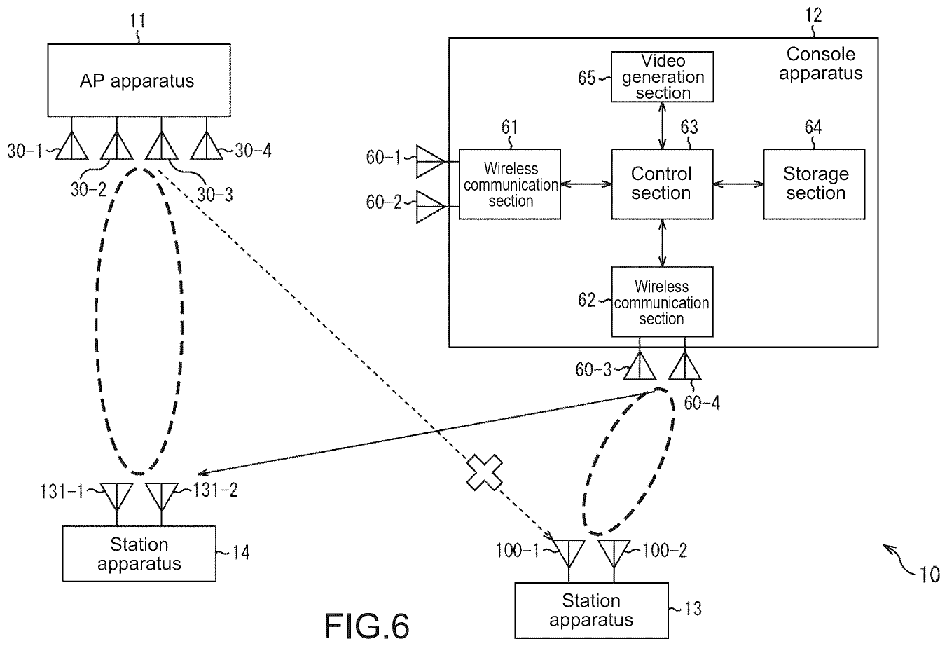

FIGS. 5 and 6 are diagrams for describing the effects of the wireless communication system 10 shown in FIG. 1.

Note that, in FIGS. 5 and 6, two antennas provided to the station apparatus 14 are antennas 131-1 and 131-2. In the following description, if it is not particularly necessary to distinguish between the antennas 131-1 and 131-2, they are collectively referred to as antenna 131.

In the wireless communication system 10, two links with different characteristics, the Fronthaul Link and the P2P Link, exist. The wireless communication between the console apparatus 12 and the station apparatus 13 via the P2P Link generally needs to transmit video information with a large amount of information, with low latency, and thus many frequency resources are required.

On the other hand, if the station apparatus 14 is executing an application such as video content or a first person shooter (FPS) game, it is also necessary to transmit a large amount of downloaded data with low latency in the wireless communication between the AP apparatus 11 and the station apparatus 14 via the Fronthaul Link. Therefore, a lot of frequency resources are required in this case.

However, in the wireless communication system 10, the Fronthaul Link and the P2P Link are used in the same channel. In this case, the Fronthaul Link and the P2P Link each perform time-division transmission according to the carrier sense multiple access/collision avoidance (CSMA/CA) protocol, which makes it difficult to perform high-capacity, low-latency transmission.

In this regard, in the wireless communication system 10, the Co-BF technology in the multiple AP coordination technology (Multi-AP Coordination) is used as the technology that allows the Fronthaul Link and the P2P Link to simultaneously perform transmission in the same channel.

Specifically, in the wireless communication system 10, as shown in FIG. 5, the AP apparatus 11 transmits data to the station apparatus 14 and also forms (a beam of) a NULL to the station apparatus 13 as a transmission destination of the console apparatus 12. At the same time, the console apparatus 12 transmits data packets to the station apparatus 13 and also forms a NULL to the station apparatus 14. This allows the AP apparatus 11 and the console apparatus 12 to simultaneously perform transmission in the same channel.

As compared to other Coordinated Tx technologies such as Coordinated orthogonal frequency division multiple access (OFDMA) and Coordinated spatial reuse (SR), the Co-BF technology is expected to provide a higher transmission capacity improvement effect. The Co-BF technology does not need to perform data sharing or transmission weight sharing among wireless terminal apparatuses of transmission sources as in the case of the Joint Tx technology.

By the way, since the AP apparatus 11 includes the four antennas 30-1 to 30-4, it can form a beam with strong directivity. Therefore, the AP apparatus 11 can transmit data to the station apparatus 14 and can also form a NULL to the station apparatus 13.

On the other hand, in the console apparatus 12, the number of antennas 60 of the wireless communication section 62 that connects to the station apparatus 13 is two, which is the same number of antennas 100 (130) of the station apparatus 13 (14). Therefore, it is difficult to form a beam with a strong directivity using only the antennas 60 of the wireless communication section 62. Therefore, the wireless communication section 62 cooperates with the other wireless communication section 61 that controls communication for the console apparatus 12 to perform wireless communication with the station apparatus 13. This allows the four antennas 60 connected to the wireless communication sections 61 and 62 to be used for the wireless communication with the station apparatus 13. Therefore, the console apparatus 12 can form a beam with a strong directivity. As a result, the console apparatus 12 can transmit data to the station apparatus 13 and also form a NULL to the station apparatus 14.

In contrast, as shown in FIG. 6, if the wireless communication section 62 does not perform wireless communication with the station apparatus 13 in cooperation with the wireless communication section 61, only the antennas 60 of the wireless communication section 62 are used to perform wireless communication with the station apparatus 13. Therefore, it is difficult for the console apparatus 12 to transmit data to the station apparatus 13 and also form a NULL to the station apparatus 14. As a result, the wireless communication between the console apparatus 12 and the station apparatus 13 interferes with the wireless communication between the AP apparatus 11 and the station apparatus 14.

As described above, in the wireless communication system 10, the wireless communication section 61 and the wireless communication section 62 cooperate to perform wireless communication with the station apparatus 13. Therefore, the console apparatus 12, which does not include many antennas as antennas for wireless communication with the station apparatus 13, can transmit data to the station apparatus 13 and also form a NULL to the station apparatus 14. Since it is generally difficult to secure a large region as an installation region for the antennas 60 and the wireless communication section 62, it is useful to need fewer antennas 60 connected to the wireless communication section 62.

Note that if the wireless communication system 10 can secure many frequency resources and allocate different frequency resources to the Fronthaul Link and the P2P Link, the Fronthaul Link and the P2P Link can perform high-capacity, low-latency wireless communication without interfering with each other. However, if the use of some frequency bands is limited by the presence of many other wireless terminal apparatuses or other wireless communication systems in the surroundings, it is difficult to allocate different frequency resources to the Fronthaul Link and the P2P Link.

The beam formed to the station apparatus 13 by the AP apparatus 11 and the beam formed to the station apparatus 14 by the console apparatus 12 do not have to be a NULL beam as long as the beam reduces interference power.

### <Description of Wireless Communication Processing>

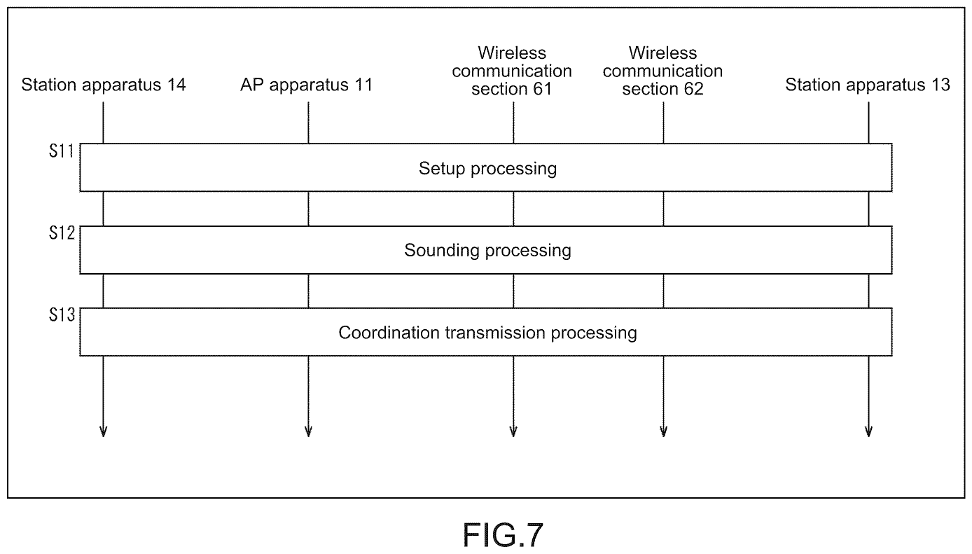

FIG. 7 is a flowchart for describing the wireless communication processing in which the AP apparatus 11 and the console apparatus 12 in the wireless communication system 10 perform coordination transmission.

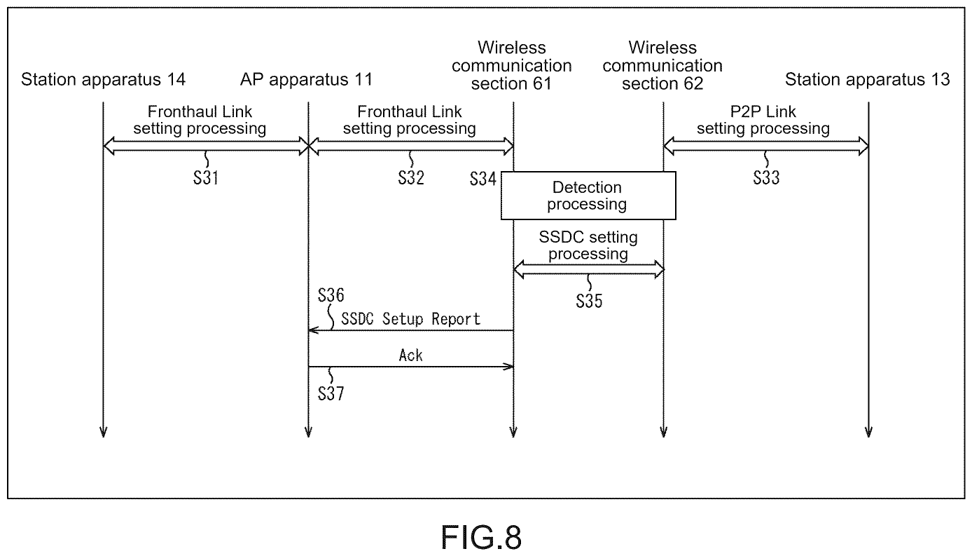

In Step S11 FIG. 7, the wireless communication system 10 performs setup processing. Details of the setup processing will be described with reference to FIG. 8 below.

In Step S12, the wireless communication system 10 performs sounding processing.

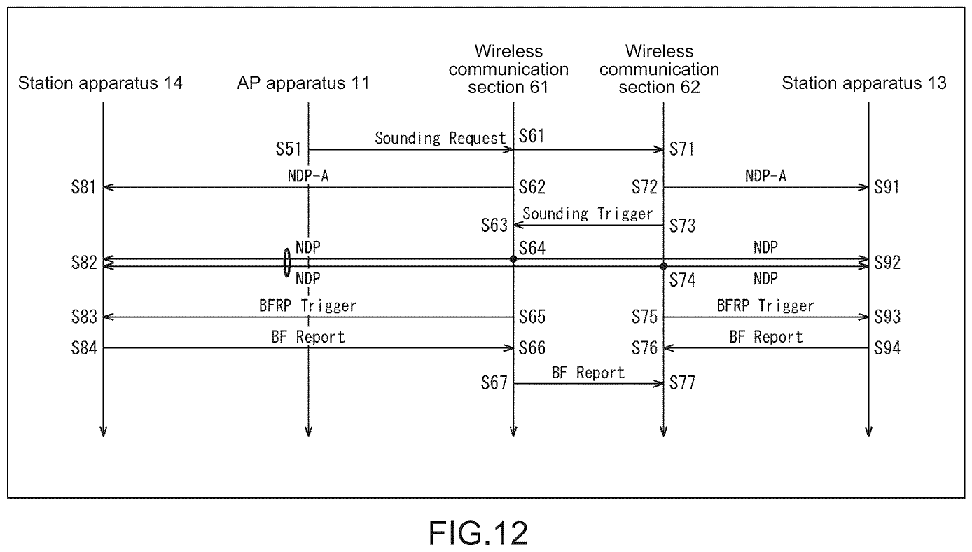

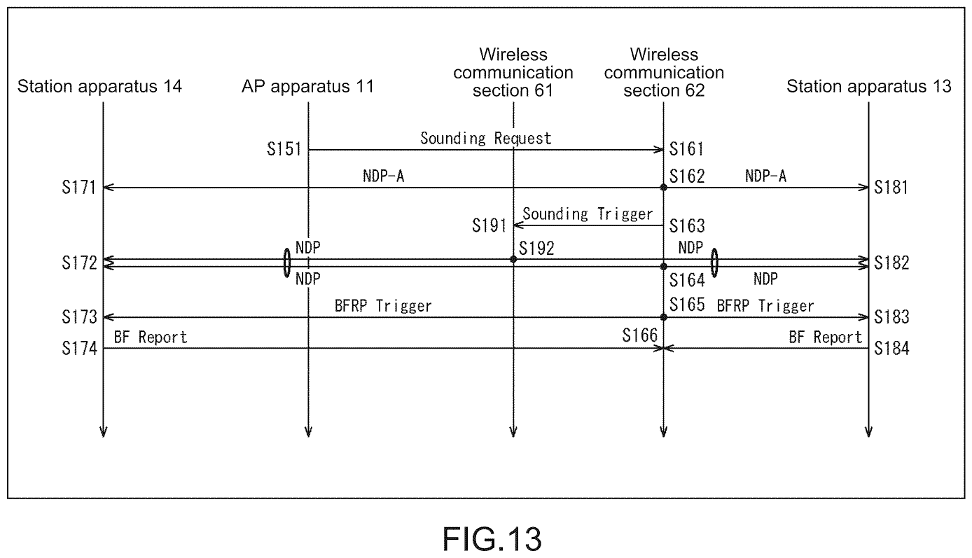

The basic sounding processing between an AP apparatus and a station apparatus is standardized in the IEEE (Institute of Electrical and Electronics Engineers) 802.11-2016 and the IEEE802.11ax. The sounding processing required to generate a transmission weight for the wireless communication using the Co-BF technology and the Joint Tx technology is described in, for example, Japanese Patent Application Laid-open No. 2022-047547. In the wireless communication system 10, sounding processing similar to the sounding processing described in, for example, Japanese Patent Application Laid-open No. 2022-047547, is performed. Details of the sounding processing in Step S12 will be described with reference to FIGS. 12 and 13 below.

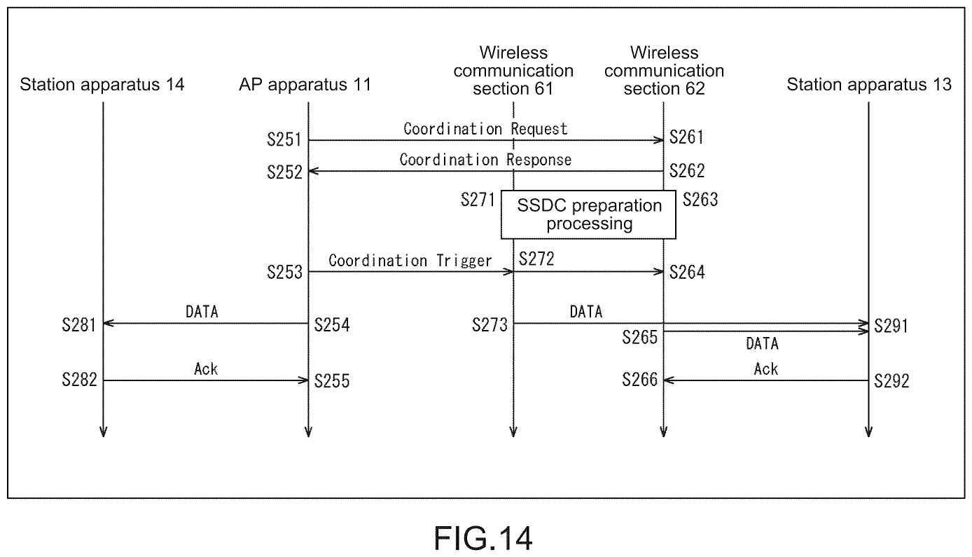

In Step S13, the wireless communication system 10 performs coordination transmission processing. The coordination transmission processing is performed when the AP apparatus 11 or the wireless communication section 62 obtains a transmission right. Details of the coordination transmission processing will be described with reference to FIG. 14 below. After the processing of Step S13, the wireless communication processing ends.

### <Description of Setup Processing>

FIG. 8 is a flowchart for describing the setup processing of Step S11 of FIG. 7.

In Step S31 of FIG. 8, the AP apparatus 11 and the station apparatus 14 perform Fronthaul Link setting processing to set the Fronthaul Link. Specifically, the AP apparatus 11 transmits a beacon, and the station apparatus 14 detects the AP apparatus 11 by receiving the beacon. The AP apparatus 11 and the station apparatus 14 then perform simple authentication processing by exchanging an Authentication Request and an Authentication Response, and perform connection processing by exchanging an Association Request and an Association Response. After the connection processing is completed, the AP apparatus 11 and the station apparatus 14 perform IEEE802.1x authentication, encryption key generation using 4-way Handshake, or the like.

Note that the AP apparatus 11 does not need to transmit a beacon by itself, and the station apparatus 14 may transmit a Probe Request to the AP apparatus 11, and the AP apparatus 11 may transmit a Probe Response in response to the Probe Request. In this case, the station apparatus 14 detects the AP apparatus 11 by receiving the Probe Response from the AP apparatus 11.

In Step S32, the AP apparatus 11 and the wireless communication section 61 perform Fronthaul Link setting processing similar to the Fronthaul Link setting processing of Step S31.

In Step S33, the wireless communication section 62 performs P2P Link setting processing to set the P2P Link with the station apparatus 13. The P2P Link setting processing is different from the Fronthaul Link setting processing of Step S31 in that the AP apparatus 11 is replaced with the wireless communication section 62 and that the station apparatus 14 is replaced with the station apparatus 13, and the other points may be similar to the Fronthaul Link setting processing. First, the wireless communication section 62 and the station apparatus 13 may each perform the Fronthaul Link setting processing with the AP apparatus 11, and then the wireless communication section 62 and the station apparatus 13 may perform the P2P Link setting processing on the initiative of the AP apparatus 11.

The processing from Steps S31 to S33 may be simultaneously performed or may be performed at different times.

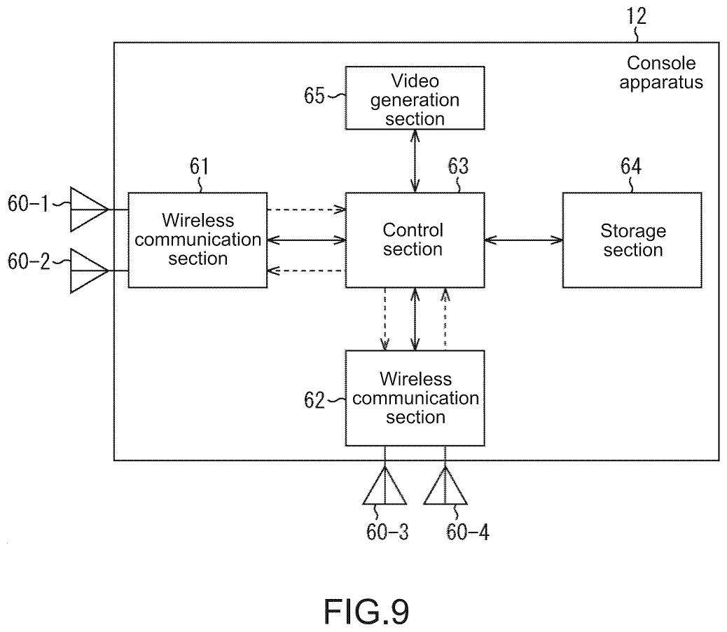

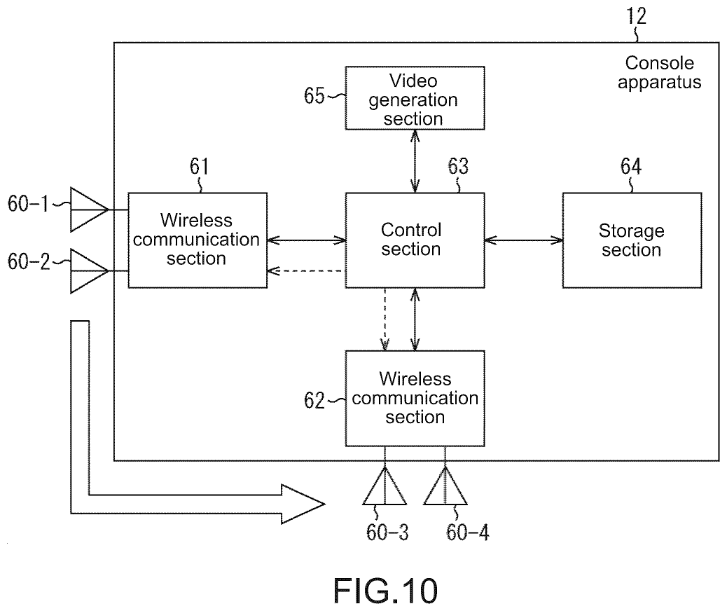

In Step S34, the wireless communication section 61 and the wireless communication section 62 perform detection processing (Same Device STAs Detection) to detect each other as the other wireless communication section that controls communication for the console apparatus 12. Details of the detection processing will be described with reference to FIGS. 9 and 10 below.

In Step S35, the wireless communication section 61 and the wireless communication section 62 perform SSDC (STAs in the Same Device Coordination) setting processing to exchange SSDC parameters that are parameters for SSDC processing. The SSDC processing is processing in which the wireless communication sections 61 and 62 that perform communication for the console apparatus 12 cooperate to perform transmission to the station apparatus 13. This SSDC processing is processing similar to the Joint Tx processing to perform transmission using the Joint Tx technology, but the Joint Tx processing differs from the SSDC processing in that the Joint Tx processing is performed within a single wireless communication section.

The SSDC parameters include at least Capability information, connection information, and authentication information of the station apparatuses 13 and 14. In the SSDC setting processing, the setting to enable DMA with the storage section 64 may be performed on the station apparatus 13 and 14. The exchange of the SSDC parameters may be performed via a bus within the console apparatus 12 or may be performed wirelessly.

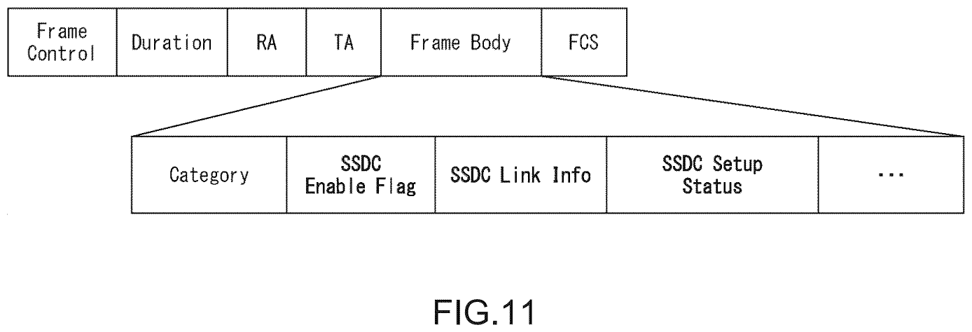

In Step S36, the wireless communication section 61 transmits an SSDC Setup Report to the AP apparatus 11, and the AP apparatus 11 receives the SSDC Setup Report. The AP apparatus 11 determines a transmission parameter during coordination transmission on the basis of the SSDC Setup Report. The frame structure of the SSDC Setup Report will be described with reference to FIG. 11 below.

In Step S37, the AP apparatus 11 transmits an ACK signal to the wireless communication section 61, and the wireless communication section 61 receives the ACK signal. The setup processing then ends.

Note that the processing of the steps of FIG. 8 do not have to be continuously performed, or the order of processing may be changed. For example, before the P2P Link setting processing of Step S33 is performed, the detection processing of Step S34 and the SSDC setting processing of Step S35 may be performed. After the processing of Steps S31 to S33 are performed, the SSDC setting processing of Step S35 may be performed at a timing at which an application starts or a timing at which the amount of traffic to be transmitted to the station apparatus 13 or 14 changes. Before the SSDC setting processing of Step S35 is performed, the setting for coordination transmission between the AP apparatus 11 and the wireless communication section 62 may be performed.

### First Example of Detection Processing

FIG. 9 is a diagram for describing a first example of the detection processing of Step S34 of FIG. 8.

In the detection processing of FIG. 9, the wireless communication sections 61 and 62 exchange information related to connection via the control section 63 to detect each other as the other wireless communication section that controls communication for the console apparatus 12.

Specifically, the communication control section 71 of the wireless communication section 61 supplies AP apparatus authentication connection information, as information related to connection in the wireless communication section 61, to the control section 63. The AP apparatus authentication connection information includes information related to the authentication processing included in the Authentication Request received from the AP apparatus 11 in the Fronthaul Link setting processing of Step S32 of FIG. 8, information related to the connection processing included in the Association Request, and other information.

The control section 63 supplies the AP apparatus authentication connection information to the wireless communication section 62. The communication control section 81 of the wireless communication section 62 acquires the AP apparatus authentication connection information supplied from the control section 63 to detect the wireless communication section 61 as the other wireless communication section that controls the communication for the console apparatus 12. In other words, the communication control section 81 detects the wireless communication section 61 as a cooperative partner in the SSDC processing.

The communication control section 81 supplies station apparatus authentication connection information, as information related to connection in the wireless communication section 62, to the control section 63. The station apparatus authentication connection information includes information related to the authentication processing and connection processing received from the station apparatus 13 in the P2P Link setting processing of Step S33 of FIG. 8 and other information.

The control section 63 supplies the station apparatus authentication connection information to the wireless communication section 61. The communication control section 71 of the wireless communication section 61 acquires the station apparatus authentication connection information supplied from the control section 63 to detect the wireless communication section 62 as the other wireless communication section that controls the communication for the console apparatus 12. In other words, the communication control section 71 detects the wireless communication section 62 as a cooperative partner in the SSDC processing.

Note that the AP apparatus authentication connection information and the station apparatus authentication connection information may have the frame structure defined by the IEEE802.11 or may have other frame structures. The control section 63 may store the acquired AP apparatus authentication connection information and station apparatus authentication connection information in the storage section 64. In this case, the control section 63 reads the AP apparatus authentication connection information stored in the storage section 64 to supply it to the wireless communication section 62, and reads the station apparatus authentication connection information to supply it to the wireless communication section 61.

### Second Example of Detection Processing

FIG. 10 is a diagram for describing a second example of the detection processing of Step S34 of FIG. 8.

In the detection processing of FIG. 10, the wireless communication section 61 wirelessly transmits random number information to be shared with the wireless communication section 62, so that the wireless communication sections 61 and 62 detect each other as the other wireless communication section that controls communication for the console apparatus 12.

Specifically, the control section 63 notifies the wireless communication sections 61 and 62 of random number information (Seed Value) and causes the wireless communication sections 61 and 62 to share the random number information. The wireless communication section 61 wirelessly transmits the random number information on a beacon signal. The wireless communication section 62 receives the beacon signal. If the random number information transmitted on the beacon signal is the same as the random number information notified by the control section 63, the communication control section 81 of the wireless communication section 62 detects the wireless communication section 61 as the other wireless communication section that controls communication for the console apparatus 12.

The wireless communication section 62 then wirelessly transmits the station apparatus authentication connection information to the wireless communication section 61. The communication control section 71 of the wireless communication section 61 receives the station apparatus authentication connection information and thus detects the wireless communication section 62 as the other wireless communication section that controls communication for the console apparatus 12. The wireless communication section 61 then wirelessly transmits the AP apparatus authentication connection information to the wireless communication section 61, and the wireless communication section 62 receives the AP apparatus authentication connection information.

In the example of FIG. 10, the wireless communication section 61 wirelessly transmits a beacon signal to the wireless communication section 62, but the wireless communication section 62 may transmit a beacon signal to the wireless communication section 61. In this case, after the AP apparatus authentication connection information is wirelessly transmitted from the wireless communication section 61, the station apparatus authentication connection information is wirelessly transmitted from the wireless communication section 62.

As described above, in the detection processing of FIG. 9, it is not necessary to perform wireless communication between the wireless communication section 61 and the wireless communication section 62, so that the detection processing of FIG. 9 can be achieved at low communication cost.

In contrast, the detection processing of FIG. 10 is easy to implement because the control section 63 only needs to notify the wireless communication sections 61 and 62 of the random number information. In the detection processing of FIG. 10, the station apparatus authentication connection information can be easily supplied to the wireless communication section 61 even if the wireless communication section 62 is located outside the console apparatus 12.

In the console apparatus 12, one of the detection processing of FIG. 9 and the detection processing of FIG. 10 may be implemented, or both of them may be implemented and selectively performed. The detection processing to be implemented in the console apparatus 12 can be selected by, for example, a developer of the console apparatus 12. This allows the developer of the console apparatus 12 to flexibly implement the detection processing, taking into account both the difficulty of implementation and the improvement in characteristics. If the detection processing of FIG. 9 and the detection processing of FIG. 10 are selectively performed, the selection may be made by the user or may be made on the basis of a congestion state of the transmission path or the like.

### <Example of Frame Structure of SSDC Setup Report>

FIG. 11 is a diagram showing an example of the frame structure of the SSDC Setup Report.

In the example of FIG. 11, the SSDC Setup Report has a frame structure of an action frame specified in the IEEE 802.11 standard.

In the SSDC Setup Report of FIG. 11, the fields of Frame Control, Duration, RA, TA, Frame Body, and FCS (Frame Check Sequence) are disposed in sequence.

In Frame Control, information indicating an SSDC Setup Report as a type of frame is stored. In Duration, information indicating a transmission period of radio waves for transmitting the SSDC Setup Report is stored. In RA, the address of the AP apparatus 11 is stored as the address of the wireless terminal apparatus that receives the SSDC Setup Report. In TA, the address of the wireless communication section 61 is stored as the address of the wireless terminal apparatus that transmits the SSDC Setup Report.

In Frame Body, the fields of Category, SSDC Enable flag, SDC Link STA Info, SSDC Setup Status, and the like are disposed in sequence.

In SSDC Enable flag, information indicating whether or not the SSDC processing can be performed is stored. In SSDC Link Info, information related to the wireless communication section 62 that performs the SSDC processing with the wireless communication section 61 is stored. This information includes identification information (STA AID) of the wireless communication section 62, operating channel information (Primary Channel), a modulation method (MCS), encryption key information, Capability information, and the like. In SSDC Setup Status, information related to the SSDC processing is stored. This information includes, for example, information indicating whether or not information can be exchanged with the wireless communication section 62 within the console apparatus 12. In FCS, information on error correction codes is stored.

Note that the SSDC Setup Report only needs to contain SSDC Enable flag, SSDC Link Info, and SSDC Setup Status. The data structure of the SSDC Setup Report is not limited to the frame structure of FIG. 11. For example, the SSDC Setup Report may have the frame structure of a MAC frame other than the action frame or may have the data structure of a transmission control protocol (TCP)/internet protocol (IP) packet (frame).

### First Example of Sounding Processing

FIG. 12 is a flowchart for describing a first example of the sounding processing of Step S12 of FIG. 7.

Note that, in the example of FIG. 12, the operating channels of the wireless communication sections 61 and 62, that is, the operating channels (Primary Channels) of the Fronthaul Link and the P2P Link, are assumed to be different. This also applies to the case in FIG. 13 below.

In Step S51 of FIG. 12, the AP apparatus 11 transmits a Sounding Request to the wireless communication sections 61 and 62 by using the OFDMA technology.

In Step S61, the wireless communication section 61 receives the Sounding Request transmitted in the processing of Step S51. In Step S71, the wireless communication section 62 receives the Sounding Request transmitted in the processing of Step S51.

In Step S62, the wireless communication section 61 transmits a null data packet (NDP) announce (NDP-A) in the operating channel. The NDP-A includes identifiers of the station apparatuses 13 and 14 that want to estimate a channel matrix, the number of antennas 60, and the like as information related to the sounding. In Step S81, the station apparatus 14 receives the NDP-A transmitted in the processing of Step S62.

In Step S72, the wireless communication section 62 transmits an NDP-A, which is the same as the NDP-A transmitted in the processing of Step S62, in the operating channel. In Step S91, the station apparatus 13 receives the NDP-A transmitted in the processing of Step S72.

In Step S73, the wireless communication section 62 wirelessly transmits a Sounding Trigger to the wireless communication section 61. In Step S63, the wireless communication section 61 receives the Sounding Trigger wirelessly transmitted in the processing of Step S73. As described above, the Sounding Trigger is transmitted from the wireless communication section 62 to the wireless communication section 61, so that the wireless communication sections 61 and 62 can establish synchronization for the subsequent processing of Steps S64 and S74.

Note that the Sounding Trigger is transmitted from the wireless communication section 62 to the wireless communication section 61 in the example of FIG. 12, but the Sounding Trigger may be transmitted from the wireless communication section 61 to the wireless communication section 62.

In Step S64, the wireless communication section 61 transmits an NDP that is a known signal for training. Simultaneously with the processing of Step S64, the wireless communication section 62 transmits an NDP in Step S74.

In Step S82, the station apparatus 14 receives the NDPs transmitted in the processing of Steps S64 and S74 and estimates a channel matrix. In Step S92, the station apparatus 13 receives the NDPs transmitted in the processing of Steps S64 and S74 and estimates a channel matrix.

Note that, in the NDPs transmitted in the processing of Steps S64 and S74, a different series is used for each of the antennas 60 that transmit the NDPs as the orthogonal series multiplied by the long training filed (LTF) section at the rear part of the signal. This allows the station apparatus 13 (14) to separate the signals transmitted from the respective antennas 60 from the received signals. As a result, the station apparatus 13 (14) can estimate the channel matrix for each combination of the antenna 60 and the antenna 100 (131).

In Step S65, the wireless communication section 61 transmits a BFRP Trigger in the operating channel. The BFRP Trigger contains information necessary to transmit a BF Report in the same operating channel using the OFDMA technology, the BF Report indicating a channel matrix of each of the combinations. In Step S83, the station apparatus 14 receives the BFRP Trigger transmitted in the processing of Step S65.

In Step S84, the station apparatus 14 transmits a BF Report, which indicates a channel matrix of each of the estimated combinations, in the operating channel on the basis of the BFRP Trigger received in the processing of Step S83. In Step S66, the wireless communication section 61 receives the BF Report transmitted in the processing of Step S84 in the operating channel, and calculates a transmission weight during the coordination transmission on the basis of the BF Report.

In Steps S75 and S76 and S93 and S94, the processing similar to the processing of Steps S65 and S66 and S83 and S84 are performed between the wireless communication section 62 and the station apparatus 13.

Note that, if there is only one channel matrix to be estimated by the station apparatus 13 (14), the BFRP Trigger is not necessary. In other words, in this case, the processing of Steps S65, S75, S83, and S93 are not performed. The BF Report may not be the channel matrix itself, or may be information necessary for the wireless communication section 61 or 62 to generate a transmission weight for coordination transmission, which is generated on the basis of the channel matrix.

In Step S67, the wireless communication section 61 transmits the BF Report received in the processing of Step S66 to the wireless communication section 62. In Step S77, the wireless communication section 62 receives the BF Report transmitted in the processing of Step S67. The sounding processing then ends.

Note that the processing of Steps S67 and S77 may be wirelessly performed, but when it is performed via the bus within the console apparatus 12, the overhead can be reduced.

As described above, in the sounding processing of FIG. 12, both the wireless communication sections 61 and 62 operate as beamformers that collect the BF Reports. Therefore, the wireless communication sections 61 and 62 can collect the BF Reports in parallel. As a result, the collection time can be reduced.

Note that in the example of FIG. 12 the operating channels of the wireless communication sections 61 and 62 are different, but may be the same. In this case, in Step S51, the AP apparatus 11 transmits a Sounding Request in the respective operating channels of the wireless communication sections 61 and 62 without using the OFDMA technology. The processing of Steps S62 and S72 are simultaneously performed.

### Second Example of Sounding Processing

FIG. 13 is a flowchart for describing a second example of the sounding processing of Step S12 of FIG. 7.

In the sounding processing of FIG. 13, the wireless communication section 61 does not operate as a beamformer that collect a BF Report.

Specifically, in Step S151, the AP apparatus 11 transmits a Sounding Request to the wireless communication section 62. In Step S161, the wireless communication section 62 receives the Sounding Request transmitted in the processing of Step S151.

In Step S162, the wireless communication section 62 transmits an NDP-A, which is the same as the NDP-A transmitted in the processing of Step S62 of FIG. 12, in the operating channels of the Fronthaul Link and the P2P Link by using the OFDMA technology. In Step S171, the station apparatus 14 receives the NDP-A transmitted in the processing of Step S162. In Step S181, the station apparatus 13 receives the NDP-A transmitted in the processing of Step S162.

In Step S163, the wireless communication section 62 wirelessly transmits a Sounding Trigger containing information related to the sounding processing to the wireless communication section 61. In Step S191, the wireless communication section 61 receives the Sounding Trigger wirelessly transmitted in the processing of Step S163. As described above, the wireless communication section 61 is notified of the Sounding Trigger by the wireless communication section 62, so that wireless communication sections 61 and 62 can share the information related to the sounding and establish synchronization for the subsequent processing of Steps S192 and S164.

The processing of Steps S192, S164, S172, and S182 are similar to the processing of Steps S64, S74, S82, and S92 of FIG. 12, and thus the description thereof will be omitted.

In Step S165, the wireless communication section 62 transmits a BFRP Trigger, which is similar to the BFRP Trigger transmitted in the processing of Step S65 of FIG. 12, in the operating channels of the Fronthaul Link and the P2P Link by using the OFDMA technology. In Step S173, the station apparatus 14 receives the BFRP Trigger transmitted in the processing of Step S165. In Step S183, the station apparatus 13 receives the BFRP Trigger transmitted in the processing of Step S165.

In Step S174, the station apparatus 14 transmits a BF Report in the operating channel on the basis of the BFRP Trigger received in the processing of Step S173, as in the processing of Step S84 of FIG. 13. In Step S184, the station apparatus 13 transmits a BF Report in the operating channel on the basis of the BFRP Trigger received in the processing of Step S173, as in the processing of Step S94.

In Step S166, the wireless communication section 61 receives the BF Report transmitted in the processing of Step S174 in the operating channel of the Fronthaul Link, and receives the BF Report transmitted in the processing of Step S184 in the operating channel of the P2P Link. The wireless communication section 61 calculates a transmission weight during coordination transmission on the basis of those BF Reports. The sounding processing then ends.

As described above, in the sounding processing of FIG. 13, only the wireless communication section 62 operates as a beamformer that collects the BF Reports. Therefore, the sounding processing can be performed even if the wireless communication section 61 does not have the function of operating as a beamformer.

### <Description of Coordination Transmission Processing>

FIG. 14 is a flowchart for describing the coordination transmission processing of Step S13 of FIG. 7.

The coordination transmission processing of FIG. 14 is started when the AP apparatus 11 obtains a transmission right to become a transmission opportunity (TXOP) owner.

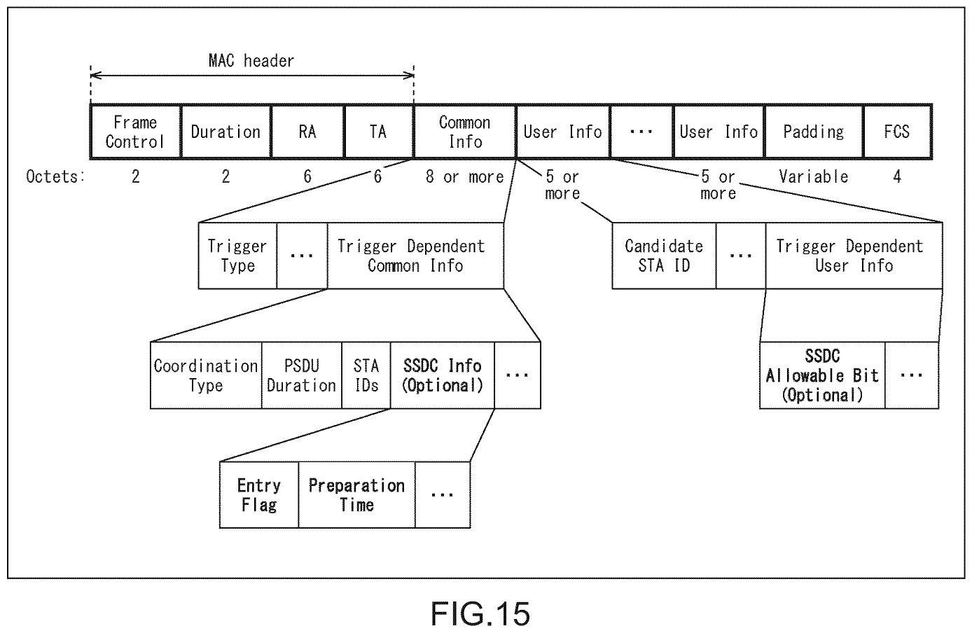

In Step S251, the AP apparatus 11 transmits a Coordination Request containing information necessary for coordination transmission to the wireless communication section 62. The frame structure of the Coordination Request will be described with reference to FIG. 15 below. In Step S261, the wireless communication section 62 receives the Coordination Request transmitted in the processing of Step S251.

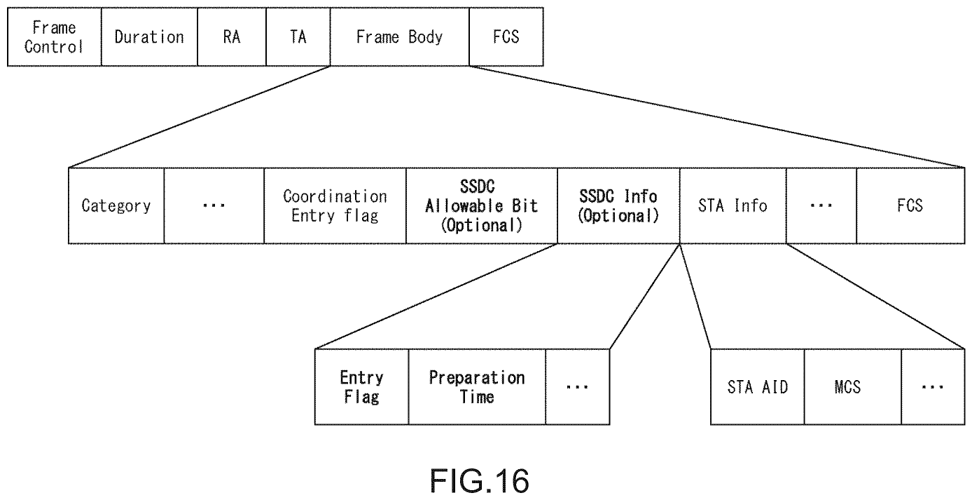

In Step S262, the wireless communication section 62 transmits a Coordination Response containing information necessary for coordination transmission to the AP apparatus 11 in response to the Coordination Request received in the processing of Step S261. The frame structure of the Coordination Response will be described with reference to FIG. 16 below.

In Step S252, the AP apparatus 11 receives the Coordination Response transmitted in the processing of Step S262. The AP apparatus 11 determines whether or not coordination transmission can be performed on the basis of the Coordination Response. In the example shown in FIG. 14, the AP apparatus 11 determines that coordination transmission can be performed. In this case, the AP apparatus 11 determines a transmission parameter during coordination transmission or the like on the basis of the Coordination Response.

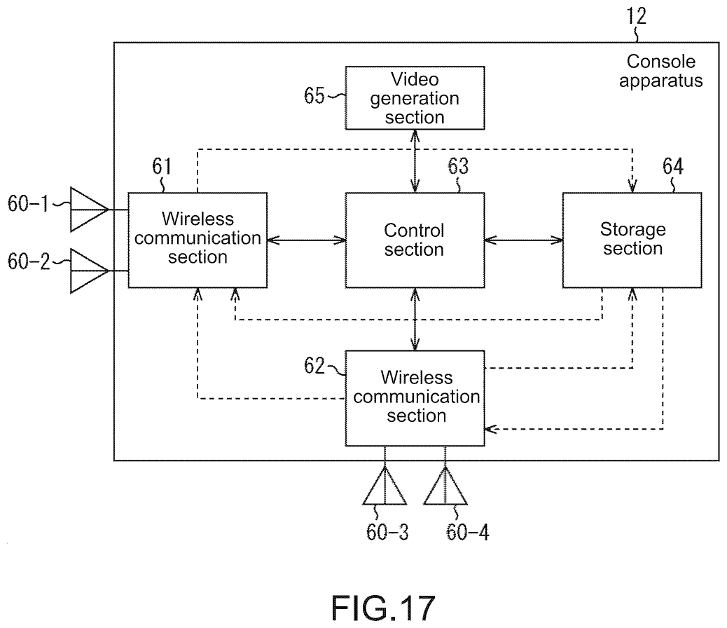

In Steps S271 and S263, the wireless communication sections 61 and 62 perform SSDC preparation processing for preparing the SSDC processing to be performed between the wireless communication sections 61 and 62. The SSDC preparation processing is processing in which the wireless communication sections 61 and 62 share video information to be transmitted and transmission parameter information (SSDC Parameter Info) related to the video information to be transmitted. Details of the SSDC processing will be described with reference to FIGS. 17 to 21 below.

Note that the AP apparatus 11 waits for coordination transmission during the period of the SSDC preparation processing. Information indicating the time required for the SSDC preparation processing, which is the waiting time, is contained in the Coordination Response. The AP apparatus 11 may refrain from performing all transmissions or may perform transmissions other than coordination transmission while waiting for coordination transmission.

After the waiting time ends, in Step S253, the AP apparatus 11 transmits a Coordination Trigger that is a synchronization signal to the wireless communication sections 61 and 62. In Step S272, the wireless communication section 61 receives the Coordination Trigger transmitted in the processing of Step S253. In Step S264, the wireless communication section 62 receives the Coordination Trigger transmitted in the processing of Step S253. This Coordination Trigger synchronizes the time and frequency of the AP apparatus 11 and the wireless communication sections 61 and 62. Note that the Coordination Trigger may be transmitted from the wireless communication section 61 to the AP apparatus 11 and the wireless communication section 62.

After the time synchronization and the frequency synchronization are performed, the AP apparatus 11 and the wireless communication sections 61 and 62 perform coordination transmission.

Specifically, in Step S273, the wireless communication section 61 performs coordination transmission on the basis of the Coordination Trigger received in Step S272. Specifically, the communication control section 71 cooperates with the wireless communication section 62 to transmit video information to be transmitted (first data) to the station apparatus 13 and also control each section to form a NULL toward the station apparatus 14.

At the same time as the processing of Step S273, in Step S265, the wireless communication section 62 performs coordination transmission on the basis of the Coordination Trigger received in Step S264. Specifically, the communication control section 81 cooperates with the wireless communication section 61 to transmit video information to be transmitted to the station apparatus 13 and also control each section to form a NULL toward the station apparatus 14.

At the same time as the processing of Steps S273 and S265, in Step S254, the AP apparatus 11 transmits predetermined data (second data) to the station apparatus 14 and also forms a NULL toward the station apparatus 13 to perform coordination transmission.

In Step S291, the station apparatus 13 receives the video information transmitted in the processing of Steps S273 and S265. In Step S292, the station apparatus 13 transmits an Ack (Block Ack) to the wireless communication section 62. In Step S266, the wireless communication section 62 receives the ACK transmitted in the processing of Step S292.

Meanwhile, in Step S281, the station apparatus 14 receives the predetermined data transmitted in the processing of Step S254. In Step S282, the station apparatus 14 transmits an Ack to the AP apparatus 11. In Step S255, the AP apparatus 11 receives the Ack transmitted in the processing of Step S282. The coordination transmission processing then ends.

Note that if the coordination transmission processing is started when the wireless communication section 62 becomes the TXOP Owner, the Coordination Request is transmitted from the wireless communication section 62 to the AP apparatus 11, and the Coordination Response is transmitted from the AP apparatus 11 to the wireless communication section 62.

The coordination transmission processing performed in Step S13 of FIG. 7 may be processing other than the coordination transmission processing of FIG. 14. For example, the AP apparatus 11 and the wireless communication section 62 may exchange an RTS (Request to Send) and a CTS (Clear to Send) before the Coordination Request and the Coordination Response are exchanged. Immediately after the transmission right is obtained, only the TXOP Owner may transmit data, and then the coordination transmission processing of FIG. 14 may be performed.

### <Example of Frame Structure of Coordination Request>

FIG. 15 is a diagram showing an example of the frame structure of the Coordination Request transmitted from the AP apparatus 11 to the wireless communication section 62 in Step S251 of FIG. 14.

In the example of FIG. 15, the Coordination Request has a frame structure of a trigger frame specified in the IEEE802.11ax.

In the Coordination Request of FIG. 15, the fields of Frame Control, Duration, RA, TA, Common Info, one or more User Info, Padding, and FCS are disposed in sequence. In Frame Control, information indicating a trigger frame as a type of frame is stored. In Duration, information indicating a transmission period of radio waves for transmitting the trigger frame is stored. In RA, the address of the wireless terminal apparatus that receives the trigger frame is stored. In TA, the address of the AP apparatus 11 is stored as the address of the wireless terminal apparatus that transmits the trigger frame.

In Common Info, the fields of Trigger Type, Trigger Dependent Common Info, and the like are disposed. In Trigger Type, information indicating the Coordination Request as a trigger frame is stored. In Trigger Dependent Common Info, information necessary for coordination transmission, such as Coordination Type, PSDU Duration, and STA IDs, are stored. The fact that Trigger Dependent Common Info is contained in the Coordination Request is recognized from the type of trigger frame stored in the Trigger Type.

Coordination Type is, for example, a 2-bit field. In Coordination Type, coordination transmission method information indicating a candidate of the coordination transmission method is stored. For example, the coordination transmission method information is 1 when the candidate of the coordination transmission method is a method using the Co-BF technology (hereinafter, referred to as Co-BF method), and is 2 when the candidate of the coordination transmission method is a method using the Joint Tx technology (hereinafter, referred to as Joint Tx method). The coordination transmission method information is 3 when the candidate of the coordination transmission method is both of the Co-BF method and the Joint Tx method.

Note that the Coordination Type may be a 4-bit field, and in Coordination Type, 2-bit AP apparatus information related to the AP apparatus that performs coordination transmission by the Co-BF method may be stored in addition to the 2-bit coordination transmission method information. For example, the AP apparatus information is 0 when the AP apparatus that performs coordination transmission by the Co-BF method is an AP apparatus that has obtained a transmission right, and is 1 when the AP apparatus is an AP apparatus that has not obtained a transmission right. The AP apparatus information is 2 when the AP apparatus that performs coordination transmission by the Co-BF method is both an AP apparatus that has obtained a transmission right and an AP apparatus that has not obtained a transmission right.

In PSDU Duration, information related to the transmission time of the data for coordination transmission is stored. In STA IDs, identification information of the wireless communication sections of one or more coordination transmission destinations are stored. Note that, if the number of pieces of identification information stored in STA IDs is more than one, the field of Num. Of STAs in which that number is stored may be provided.

In User Info, the fields of Candidate STA ID, Trigger Dependent User Info, and the like are disposed. In Trigger Dependent User Info, SSDC Allowable Bit that is flag information indicating whether to permit SSDC processing is stored. For example, if the AP apparatus 11 performs transmission to the wireless communication section 61, the SSDC Allowable Bit of the Coordination Request transmitted from the AP apparatus 11 to the wireless communication section 62 indicates that the SSDC processing is not permitted.

Note that when the Coordination Request is transmitted from the wireless communication section 62 to the AP apparatus 11, the field of SSDC Info is disposed after STA IDs in the Coordination Request as shown in FIG. 15, and SSDC Allowable Bit is not disposed. In SSDC Info, SSDC information related to the SSDC processing is stored. The SSDC information contains, for example, Entry Flag indicating that SSDC processing can be performed, Preparation Time indicating a necessary time of the SSDC preparation processing, and the like. The AP apparatus 11 determines a waiting time for the coordination transmission on the basis of that Preparation Time.

The Coordination Request only needs to contain Coordination Type, PSDU Duration, STA IDs, and SSDC Info or SSDC Allowable Bit, and the data structure of the Coordination Request is not limited to the frame structure of FIG. 15. For example, the Coordination Request may have the frame structure of a MAC frame other than the trigger frame or may include the data structure of a TCP/IP packet. In particular, the Coordination Request transmitted from the wireless communication section 62 to the AP apparatus 11 does not need to have the data structure of the trigger frame.

### <Example of Frame Structure of Coordination Response>

FIG. 16 is a diagram showing an example of the frame structure of the Coordination Response transmitted from the wireless communication section 62 to the AP apparatus 11 in Step S262 of FIG. 14.

In the example of FIG. 16, the Coordination Response has a frame structure of an action frame specified in the IEEE802.11.

In the Coordination Response of FIG. 16, the fields of Frame Control, Duration, RA, TA, Frame Body, and FCS are disposed in sequence. In Frame Body, the fields of Category, Coordination Entry flag, SSDC Info, STA Info, FCS, and the like are disposed in sequence.

Coordination Entry flag is, for example, a 2-bit field. In Coordination Entry flag, a coordination transmission enable/disable flag indicating whether coordination transmission can be performed or not is stored. This coordination transmission enable/disable flag is set, for example, for each coordination transmission method. For example, if the coordination transmission of the Co-BF method can be performed, 1 is stored in Coordination Entry flag, and if the coordination transmission of the Joint Tx method can be performed, 2 is stored in Coordination Entry flag. If both the coordination transmission of the Co-BF method and of the Joint Tx method can be performed, 3 is stored in Coordination Entry flag, and if the coordination transmission of both methods cannot be performed, 0 is stored in Coordination Entry flag.

In STA Info, for example, STA AID that is identification information of the wireless communication section, MCS indicating a modulation method, and the like are stored as information related to the wireless communication section of a coordination transmission destination. One or more pieces of STA Info may be disposed. If a plurality of pieces of STA Info is disposed, the field of Num. Of STA Info indicating the number of pieces of STA Info may be provided before STA Info.

Note that if the Coordination Response is transmitted from the AP apparatus 11 to the wireless communication section 62, in the Coordination Response, SSDC Allowable Bit is disposed after Coordination Entry flag as shown in FIG. 16, and SSDC Info is not disposed.

### <First Example of SSDC Preparation Processing>

FIG. 17 is a diagram for describing a first example of the SSDC preparation processing of FIG. 14.

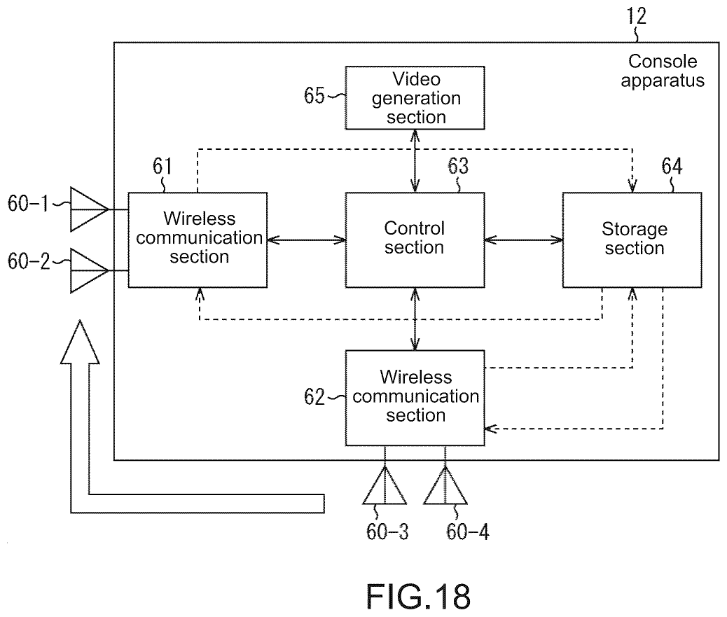

Note that in the example of FIG. 17 the DMA to the storage section 64 is enabled in the console apparatus 12. This is similarly applied to FIGS. 18 to 21 below.

In the SSDC preparation processing of FIG. 17, the wireless communication sections 61 and 62 acquire unmodulated video information to be transmitted from the storage section 64 to share the unmodulated video information to be transmitted.

Specifically, first, the communication control section 81 of the wireless communication section 62 requests the storage section 64 to provide unmodulated video information to be transmitted (Plain DATA). The storage section 64 supplies the stored unmodulated video information to be transmitted to the wireless communication section 62 in response to the request. The storage section 64 retains that video information for a certain period of time even after supplying the video information to the wireless communication section 62. This retention period is indicated, for example, by the wireless communication section 62 and the control section 63.

The communication control section 81 acquires the unmodulated video information to be transmitted, which has been supplied from the storage section 64, to share the unmodulated video information to be transmitted with the wireless communication section 61. The wireless communication section 62 performs modulation or the like on the unmodulated video information to be transmitted on the basis of modulation information related to modulation, and generates a symbol stream to be transmitted.

Next, the communication control section 81 supplies transmission parameter information to the wireless communication section 61 via the bus within the console apparatus 12 to share the transmission parameter information with the wireless communication section 61. The communication control section 71 of the wireless communication section 61 acquires the transmission parameter information supplied from the communication control section 81 to share the transmission parameter information with the wireless communication section 62.

The transmission parameter information contains address information of the storage section 64 in which the video information to be transmitted is stored, generation-related information, and the like. The generation-related information is information necessary for the wireless communication section 61 to generate a symbol stream that is the same as the symbol stream to be transmitted, which is generated in the wireless communication section 62. Specifically, the generation-related information is a sequence number, encryption key information, a modulation method as modulation information, a coding method, a transmission weight, or the like. The transmission weight is determined by the wireless communication section 62 on the basis of the BF Report obtained in the sounding processing.

Next, the communication control section 71 requests the storage section 64 to provide unmodulated video information to be transmitted on the basis of the address information in the transmission parameter information. The storage section 64 supplies the stored unmodulated video information to be transmitted to the wireless communication section 61 in response to the request. The communication control section 71 acquires the unmodulated video information to be transmitted supplied from the storage section 64 to share the unmodulated video information to be transmitted with the wireless communication section 62. The wireless communication section 61 performs modulation, similar to that performed by the wireless communication section 62, on the unmodulated video information to be transmitted on the basis of the generation-related information in the transmission parameter information, and generates a symbol stream to be transmitted. Thus, the symbol streams to be transmitted, which have been generated in the wireless communication sections 61 and 62, are the same.

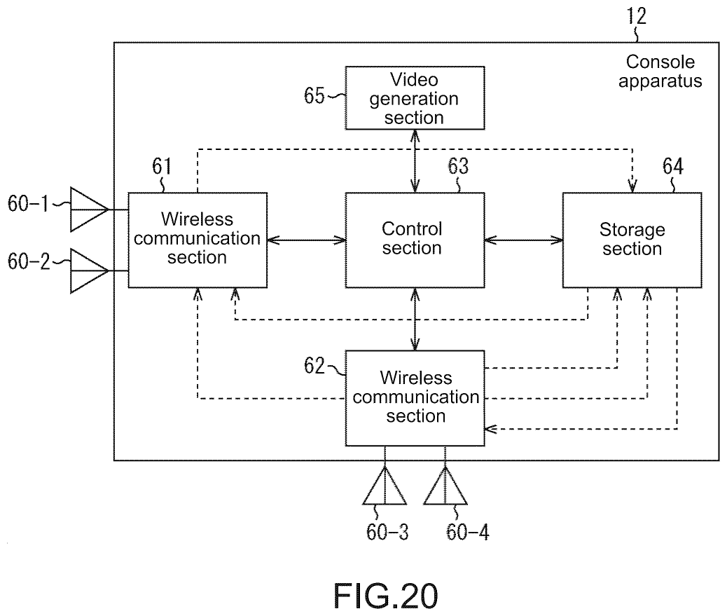

Note that DMA is enabled in the example of FIG. 17, and thus the wireless communication sections 61 and 62 access the storage section 64 directly, but the wireless communication sections 61 and 62 may also access the storage section 64 via the control section 63. The transmission parameter information may also be transmitted from the wireless communication section 62 to the wireless communication section 61 via the control section 63. This is similarly applied to FIG. 20 below.

### Second Example of SSDC Preparation Processing

FIG. 18 is a diagram for describing a second example of the SSDC preparation processing of FIG. 14.

The SSDC preparation processing of FIG. 18 is different from the SSDC preparation processing of FIG. 17 in that the transmission parameter information is wirelessly transmitted from the wireless communication section 62 to the wireless communication section 61, and is the same as the SSDC preparation processing of FIG. 17 in the other points.

In the SSDC preparation processing of FIG. 18, the transmission parameter information is shared through wireless communication, and the unmodulated video information to be transmitted is shared via the storage section 64, so that this is suitable when the wireless communication section 62 is located outside the console apparatus 12.

### Third Example of SSDC Preparation Processing

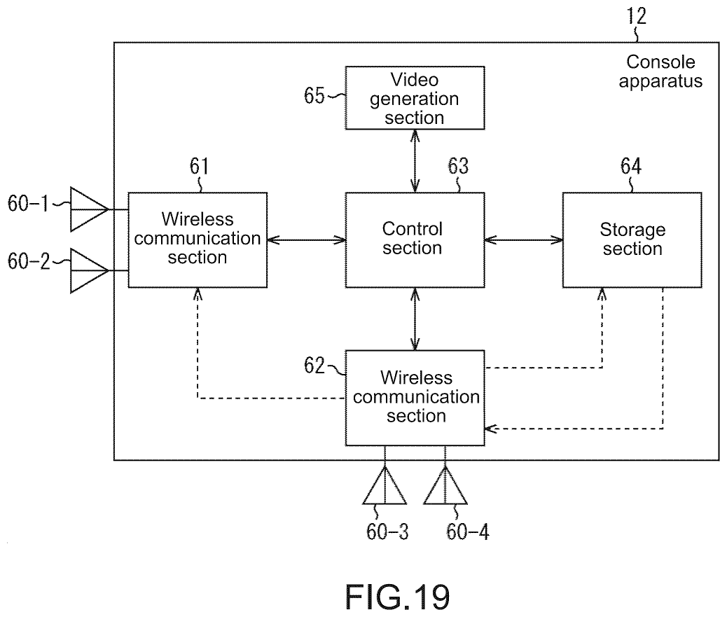

FIG. 19 is a diagram for describing a third example of the SSDC preparation processing of FIG. 14.

In the SSDC preparation processing of FIG. 19, the wireless communication section 62 supplies video information that has been subjected to processing such as modulation (Modulated DATA) to the wireless communication section 61, so that the wireless communication sections 61 and 62 share the processed video information to be transmitted.

Specifically, first, similar to the SSDC preparation processing of FIG. 17, the communication control section 71 of the wireless communication section 62 acquires unmodulated video information to be transmitted from the storage section 64. The wireless communication section 62 performs processing such as modulation on the unmodulated video information, and generates a symbol stream to be transmitted. Further, the communication control section 81 supplies the processed video information to the wireless communication section 61 via the bus within the console apparatus 12 to share it with the wireless communication section 61, and also supplies the transmission parameter information to the wireless communication section 61.

The processed video information is video information processed by the data processing section 83 or video information processed by the signal processing section 84. As described above, the generation-related information is information necessary for the wireless communication section 61 to generate a symbol stream that is the same as the symbol stream to be transmitted, which is generated in the wireless communication section 62. Therefore, the type or number of information contained in the generation-related information differs depending on that the processed video information supplied to the wireless communication section 61 is the video information processed by the data processing section 83 or the video information processed by the signal processing section 84.

The communication control section 71 of the wireless communication section 61 acquires the processed video information to be transmitted from the communication control section 81 via the bus within the console apparatus 12 to share it with the wireless communication section 62, and also acquires the transmission parameter information. The wireless communication section 61 generates, as a symbol stream to be transmitted, a symbol stream that is the same as the symbol stream to be transmitted generated by the wireless communication section 62 from the processed video information to be transmitted, on the basis of the transmission parameter information.

Note that DMA is enabled in the example of FIG. 19, and thus the wireless communication section 62 accesses the storage section 64 directly, but the wireless communication section 62 may also access the storage section 64 via the control section 63. The transmission parameter information may also be transmitted from the wireless communication section 62 to the wireless communication section 61 via the control section 63.

In the SSDC preparation processing of FIG. 19, the processed video information to be transmitted is supplied from the wireless communication section 62 to the wireless communication section 61. Therefore, even if the data processing section 73 and the signal processing section 74 fail to perform processing in a similar manner to the data processing section 83 and the signal processing section 84, the wireless communication sections 61 and 62 can perform the SSDC processing to transmit the same symbol stream.

For example, even if encoding in the data processing section 83 cannot be performed in the data processing section 73 or if the wireless communication section 61 does not have the function of operating as a beamformer and fails to calculate a transmission weight, the SSDC processing can be performed.

Note that the processed video information contains a large amount of information, and thus it is difficult to wirelessly transmit the processed video information to be transmitted from the wireless communication section 62 to the wireless communication section 61 in the SSDC preparation processing of FIG. 19.

### Fourth Example of SSDC Preparation Processing

FIG. 20 is a diagram showing a fourth example of the SSDC preparation processing of FIG. 14.

In the SSDC preparation processing of FIG. 20, the wireless communication section 61 acquires the processed video information from the wireless communication section 62 via the storage section 64, so that the wireless communication sections 61 and 62 share the processed video information to be transmitted.

Specifically, first, similar to the SSDC preparation processing of FIG. 19, the wireless communication section 62 acquires unmodulated video information to be transmitted from the storage section 64, and performs processing such as modulation on that video information to generate a symbol stream to be transmitted. The communication control section 81 of the wireless communication section 62 supplies the processed video information to the storage section 64 and causes the storage section 64 to store the processed video information, to share it with the wireless communication section 61.

Next, the communication control section 81 supplies the transmission parameter information to the wireless communication section 61 via the bus within the console apparatus 12. The communication control section 71 of the wireless communication section 61 requests the storage section 64 to provide the processed video information to be transmitted on the basis of address information contained in the transmission parameter information. The storage section 64 supplies the stored processed video information to be transmitted to the wireless communication section 61 in response to the request. The communication control section 81 acquires that video information to share the processed video information to be transmitted with the wireless communication section 61. The wireless communication section 61 generates, as a symbol stream to be transmitted, a symbol stream that is the same as the symbol stream to be transmitted generated by the wireless communication section 62 from the processed video information to be transmitted, on the basis of the transmission parameter information.

### Fifth Example of SSDC Preparation Processing

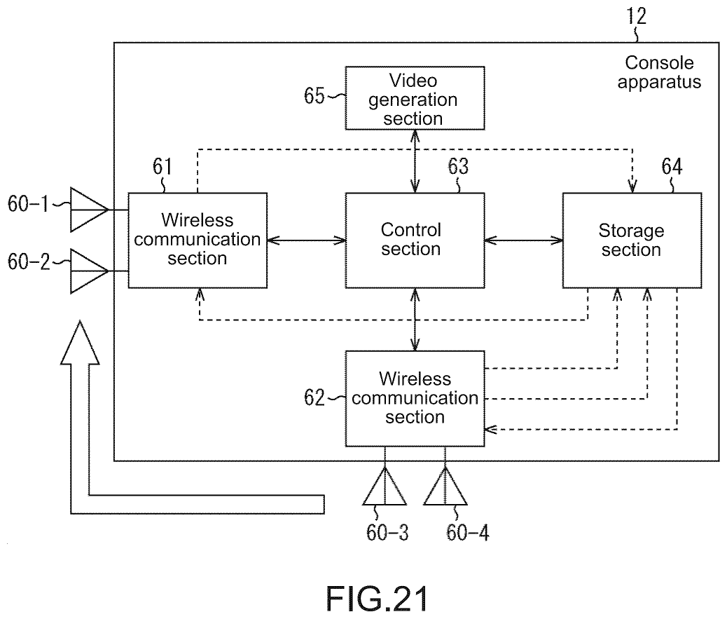

FIG. 21 is a diagram for describing a fifth example of the SSDC preparation processing of FIG. 14.

The SSDC preparation processing of FIG. 21 is different from the SSDC preparation processing of FIG. 20 in that the transmission parameter information is wirelessly transmitted from the wireless communication section 62 to the wireless communication section 61, and is the same as the SSDC preparation processing of FIG. 20 in the other points.

In the SSDC preparation processing of FIG. 21, the transmission parameter information is shared through wireless communication, and the processed video information to be transmitted is shared via the storage section 64, so that this is suitable when the wireless communication section 62 is located outside the console apparatus 12.

As described above, in the SSDC preparation processing of FIGS. 20 and 21, the processed video information to be transmitted can be supplied from the wireless communication section 62 to the wireless communication section 61 via the storage section 64. Therefore, even if the wireless communication sections 61 and 62 fail to perform communication via the bus within the console apparatus 12, the processed video information to be transmitted can be shared. It should be noted that the processed video information to be transmitted is stored in the storage section 64 and thus takes up the capacity of the storage section 64 as compared to the SSDC preparation processing of FIG. 19. The amount of processing between the wireless communication sections 61 and 62 and the storage section 64 increases as compared to the SSDC preparation processing of FIG. 19.

Note that the request for video information, provided to the storage section 64 by the wireless communication section 62, and the acquisition of the video information from the storage section 64, which are performed in the SSDC preparation processing of FIGS. 17 to 21, may be performed prior to the SSDC preparation processing. The wireless communication section 62 does not have to request video information from the storage section 64.

In Steps S271 and S263 of FIG. 14, for example, those who implement the wireless communication sections 61 and 62 can select which processing of the SSDC preparation processing of FIGS. 17 to 21 is to be performed by the wireless communication sections 61 and 62. This allows those who implement the wireless communication sections 61 and 62 to flexibly implement the SSDC preparation processing, taking into account both the difficulty of implementation and the improvement in characteristics.

As described above, the wireless communication section 61 (62) includes the communication control section 71 (81) that controls communication for the console apparatus 12. The communication control section 71 (81) cooperates with the other wireless communication section 62 (61), which controls the communication for the console apparatus 12, to thereby control transmission of video information to the station apparatus 13. Therefore, when there is a wireless communication section 61 that controls communication for the same console apparatus 12 in addition to a wireless communication section 62 that does not connect to the four antennas 60, it is possible to perform transmission in the wireless communication section 62 using the four antennas 60. This allows the console apparatus 12 to form a beam with a strong directivity.

As a result, the console apparatus 12 can transmit video information to the station apparatus 13 and also form a NULL to the station apparatus 14. In other words, the console apparatus 12 can reduce interference given to the station apparatus 14 without reducing the received power of the station apparatus 13. Therefore, the AP apparatus 11 and the console apparatus 12 can perform coordination transmission. As a result, in the wireless communication system 10, the effects such as the improvement in throughput and the reduction in transmission delays due to reduction in waiting time for transmission are obtained.

Note that the SSDC processing can be performed also in the cases other than the case where the AP apparatus 11 and the console apparatus 12 perform coordination transmission. For example, the SSDC processing may be performed in the case of increasing the number of streams during MIMO transmission to the station apparatus 13 or in the cases except the case of coordination transmission necessary to increase the number of antennas to form a highly directional beam.

### <2. Computer>

At least part of the series of processing described above can be executed by hardware or can also be executed by software. If the series of processing is executed by software, a program configuring that software is installed on a computer. Here, the computer includes a computer incorporated in dedicated hardware and, for example, a general-purpose personal computer that can execute various functions by installing various programs therein.

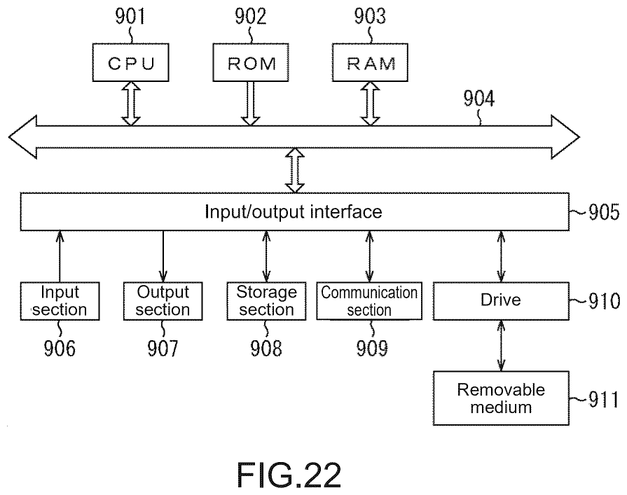

FIG. 22 is a block diagram showing a hardware configuration example of a computer that executes at least part of the series of processing described above by a program.

In the computer, a central processing unit (CPU) 901, a read only memory (ROM) 902, and a random access memory (PAM) 903 are mutually connected by a bus 904.

In addition, an input/output interface 905 is connected to the bus 904. Connected to the input/output interface 905 are an input section 906, an output section 907, a storage section 908, a communication section 909, and a drive 910.

The input section 906 includes a keyboard, a mouse, a microphone, and the like. The output section 907 includes a display, a speaker, and the like. The storage section 908 includes a hard disk, a nonvolatile memory, and the like. The communication section 909 includes a network interface and the like. The drive 910 drives a removable medium 911 such as a magnetic disk, an optical disc, a magneto optical disk, or a semiconductor memory.

In the computer configured as described above, the series of processing described above is performed by the CPU 901, for example, loading a program stored in the storage section 908 to the RAM 903 via the input/output interface 905 and the bus 904 and executing the program.

Programs to be executed by the computer (CPU 901) can be provided, for example, by being recorded on the removable medium 911 as packaged media. Programs can also be provided via a wired or wireless transmission medium such as a local area network, the Internet, or digital satellite broadcasting.

In the computer, a program can be installed on the storage section 908 via the input/output interface 905 by mounting the removable medium 911 to the drive 910. Programs can also be received by the communication section 909 via a wired or wireless transmission medium and installed on the storage section 908. Other programs can be installed in advance on the ROM 902 or the storage section 908.

Note that the programs to be executed by the computer may be programs that are processed chronologically according to the order described herein, or may be programs that are processed in parallel or at the necessary timing, such as when a call is made.

The embodiments of the present technology are not limited to the embodiments described above, and can be variously modified without departing from the spirit of the present technology.

For example, the present technology can have a configuration of cloud computing in which a single function is shared and cooperatively processed by a plurality of apparatuses through a network.

Further, the steps described in the flowcharts described above can be executed by one apparatus or shared and executed by a plurality of apparatuses.

Furthermore, in the case where one step includes a plurality of processing steps, the plurality of processing steps in one step can be executed by one apparatus or shared and executed by a plurality of apparatuses.

Note that the effects described herein are merely exemplary ones and are not restrictive ones, and any other effects may be produced.

The present technology can have the following configurations.

(1) A wireless communication control device, including
a communication control section that controls communication for a first wireless terminal apparatus, and controls transmission of first data to a second wireless terminal apparatus in cooperation with another wireless communication control device that controls the communication for the first wireless terminal apparatus.
   (2) The wireless communication control device according to (1), in which
the communication control section is configured to detect the other wireless communication control device.
   (3) The wireless communication control device according to (2), in which
the communication control section is configured to acquire information related to connection in the other wireless communication control device to detect the other wireless communication control device.
   (4) The wireless communication control device according to (2), in which
the communication control section is configured to receive random number information from the other wireless communication control device, the random number information being shared with the other wireless communication control device, to detect the other wireless communication control device.
   (5) The wireless communication control device according to any one of (1) to (4), in which
the communication control section is configured to control transmission of information related to the other wireless communication control device to a third wireless terminal apparatus that connects to the communication control section.
   (6) The wireless communication control device according to any one of (1) to (4), in which
the communication control section is configured to control transmission of information related to transmission performed in cooperation with the other wireless communication control device to a third wireless terminal apparatus that connects to the communication control section.
   (7) The wireless communication control device according to any one of (1) to (6), in which
the communication control section is configured to share the first data with the other wireless communication control device.
   (8) The wireless communication control device according to (7), in which
the communication control section is configured to acquire unmodulated first data stored in a storage section to share the unmodulated first data with the other wireless communication control device.
   (9) The wireless communication control device according to (8), further including
a modulation section that modulates the unmodulated first data on the basis of modulation information related to modulation of the first data, the modulation information being to be shared with the other wireless communication control device, in which
the communication control section is configured to control transmission of the first data modulated by the modulation section.
   (10) The wireless communication control device according to (7), further including
a modulation section that modulates the first data, in which
the communication control section is configured to supply the first data modulated by the modulation section to the other wireless communication control device to share the modulated first data with the other wireless communication control device, and to control transmission of the modulated first data to the second wireless terminal apparatus.
   (11) The wireless communication control device according to (10), in which
the communication control section is configured to supply the modulated first data to the other wireless communication control device via a storage section to share the modulated first data with the other wireless communication control device.
   (12) The wireless communication control device according to (7), in which
the communication control section is configured to acquire the first data modulated in the other wireless communication control device from the other wireless communication control device to share the modulated first data with the other wireless communication control device, and to control transmission of the modulated first data to the second wireless terminal apparatus.
   (13) The wireless communication control device according to (12), in which
the communication control section is configured to acquire the first data modulated in the other wireless communication control device from the other wireless communication control device via a storage section to share the modulated first data with the other wireless communication control device.
   (14) The wireless communication control device according to any one of (1) to (4) and (7) to (13), in which
one of the wireless communication control device and the other wireless communication control device is configured to connect to the second wireless terminal apparatus via a first link, and
another one of the wireless communication control device and the other wireless communication control device is configured to connect to a third wireless terminal apparatus via a second link.
   (15) The wireless communication control device according to (14), in which
the communication control section is configured to control, in cooperation with the other wireless communication control device, transmission of the first data to the second wireless terminal apparatus and formation of a NULL to a fourth wireless terminal apparatus that connects to the third wireless terminal apparatus via the second link.
   (16) The wireless communication control device according to (15), in which
the third wireless terminal apparatus is configured to transmit second data to the fourth wireless terminal apparatus and also form the NULL to the second wireless terminal apparatus, simultaneously with the transmission of the first data and the formation of the NULL that are controlled by the communication control section.
   (17) The wireless communication control device according to (16), in which
the communication control section is configured to transmit information to the third wireless terminal apparatus in cooperation with the other wireless communication control device, the information indicating a time used to prepare the transmission of the first data and the formation of the NULL.
   (18) A wireless communication control method for a wireless communication control device, the method including
a communication control step of controlling communication for a first wireless terminal apparatus, and controlling transmission of first data to a second wireless terminal apparatus in cooperation with another wireless communication control device that controls the communication for the first wireless terminal apparatus.

### REFERENCE SIGNS LIST

11 AP apparatus
12 console apparatus
13, 14 station apparatus
61, 62 wireless communication section
64 storage section
71 communication control section
73 data processing section
74 signal processing section
81 communication control section
83 data processing section
84 signal processing section

1. A wireless communication control device, comprising
a communication control section that controls communication for a first wireless terminal apparatus, and controls transmission of first data to a second wireless terminal apparatus in cooperation with another wireless communication control device that controls the communication for the first wireless terminal apparatus.

2. The wireless communication control device according to claim 1, wherein
the communication control section is configured to detect the other wireless communication control device.

3. The wireless communication control device according to claim 2, wherein
the communication control section is configured to acquire information related to connection in the other wireless communication control device to detect the other wireless communication control device.

4. The wireless communication control device according to claim 2, wherein
the communication control section is configured to receive random number information from the other wireless communication control device, the random number information being shared with the other wireless communication control device, to detect the other wireless communication control device.

5. The wireless communication control device according to claim 1, wherein
the communication control section is configured to control transmission of information related to the other wireless communication control device to a third wireless terminal apparatus that connects to the communication control section.

6. The wireless communication control device according to claim 1, wherein
the communication control section is configured to control transmission of information related to transmission performed in cooperation with the other wireless communication control device to a third wireless terminal apparatus that connects to the communication control section.

7. The wireless communication control device according to claim 1, wherein
the communication control section is configured to share the first data with the other wireless communication control device.

8. The wireless communication control device according to claim 7, wherein
the communication control section is configured to acquire unmodulated first data stored in a storage section to share the unmodulated first data with the other wireless communication control device.

9. The wireless communication control device according to claim 8, further comprising
a modulation section that modulates the unmodulated first data on a basis of modulation information related to modulation of the first data, the modulation information being to be shared with the other wireless communication control device, wherein
the communication control section is configured to control transmission of the first data modulated by the modulation section.

10. The wireless communication control device according to claim 7, further comprising
a modulation section that modulates the first data, wherein
the communication control section is configured to supply the first data modulated by the modulation section to the other wireless communication control device to share the modulated first data with the other wireless communication control device, and to control transmission of the modulated first data to the second wireless terminal apparatus.

11. The wireless communication control device according to claim 10, wherein
the communication control section is configured to supply the modulated first data to the other wireless communication control device via a storage section to share the modulated first data with the other wireless communication control device.

12. The wireless communication control device according to claim 7, wherein
the communication control section is configured to acquire the first data modulated in the other wireless communication control device from the other wireless communication control device to share the modulated first data with the other wireless communication control device, and to control transmission of the modulated first data to the second wireless terminal apparatus.

13. The wireless communication control device according to claim 12, wherein
the communication control section is configured to acquire the first data modulated in the other wireless communication control device from the other wireless communication control device via a storage section to share the modulated first data with the other wireless communication control device.

14. The wireless communication control device according to claim 1, wherein
one of the wireless communication control device and the other wireless communication control device is configured to connect to the second wireless terminal apparatus via a first link, and
another one of the wireless communication control device and the other wireless communication control device is configured to connect to a third wireless terminal apparatus via a second link.

15. The wireless communication control device according to claim 14, wherein
the communication control section is configured to control, in cooperation with the other wireless communication control device, transmission of the first data to the second wireless terminal apparatus and formation of a NULL to a fourth wireless terminal apparatus that connects to the third wireless terminal apparatus via the second link.

16. The wireless communication control device according to claim 15, wherein
the third wireless terminal apparatus is configured to transmit second data to the fourth wireless terminal apparatus and also form the NULL to the second wireless terminal apparatus, simultaneously with the transmission of the first data and the formation of the NULL that are controlled by the communication control section.

17. The wireless communication control device according to claim 16, wherein
the communication control section is configured to transmit information to the third wireless terminal apparatus in cooperation with the other wireless communication control device, the information indicating a time used to prepare the transmission of the first data and the formation of the NULL.

18. A wireless communication control method for a wireless communication control device, the method comprising
a communication control step of controlling communication for a first wireless terminal apparatus, and controlling transmission of first data to a second wireless terminal apparatus in cooperation with another wireless communication control device that controls the communication for the first wireless terminal apparatus.
